(19) United States
(12) Patent Application Publication
(10) Pub. No.: US 2016/0217418 A1
(43) Pub. Date: Jul. 28, 2016

(54) SYSTEM AND METHOD FOR LOST ITEM MANAGEMENT

(71) Applicant: Searchlight Technical Solutions, Oceanside, NY (US)

(72) Inventor: Paul Stutzbach, Baldwin, NY (US)

(21) Appl. No.: 15/004,032

(22) Filed: Jan. 22, 2016

Related U.S. Application Data
(60) Provisional application No. 62/106,530, filed on Jan. 22, 2015.

(51) Int. Cl. G06Q 10/08; G06F 17/30

(52) U.S. Cl. CPC G06Q 10/087; G06F 17/30525; G06F 17/30864

(57) ABSTRACT

A lost item management system and method is provided for matching found items with lost item inquiries provided by customers. An item processing module is configured to accept and store item attributes of the found items as parts of item entries, wherein each of the item entries has a set of the item attributes. An inquiry processing module is configured to accept and store inquiry attributes, corresponding to attributes of the lost items, as parts of inquiry entries. An item matching module is configured to execute a match search comparing the item attributes of the item entries with the inquiry attributes of the inquiry entries and identify possible matches. A monitoring module is configured to actuate the item matching module, in accordance with a schedule, to execute the match search and notify the operator when possible matches are identified by the match search.

### TECHNICAL FIELD

The present invention relates to a system and method for the management of items which are to be stored, held and retrieved, and for managing lost items which are found and submitted for reclaiming by owners.

### BACKGROUND

Item management systems are used for managing items such as luggage and other personal effects of travelers. These systems are employed at various locations involving travel as travelers often need to manage luggage and other articles during travel when circumstances dictate that the articles are stored for later retrieval or forwarding to specified destinations. Additionally, such systems have permitted lost items found by third parties to be registered. The systems generally register location and type of items in storage, the associated owners if applicable, and an expected time period after which items are produced from storage to be reclaimed by the owners in person or shipped to the owners. Owners of lost items may make an inquiry to determine if a particular lost item has been registered in the system by searching a database of the system. If an item is not found by the search the owner may later conduct another search to determine if the lost item has been subsequently registered in the system.

When attempting to locate a lost item, the lost item owner contacts an operator of the item management system and provides a description of the lost item along with when and where, if known, the item was lost. Alternatively, the owner may access a website for the system and enter the aforesaid information. Based on the information, a database of lost items is queried and possible matches are identified. The owner of the lost item then reviews the results of the query and either submits a claim for an identified item the results of the query or, if no item appears to be the lost item, the lost item owner must later make another search to see of the lost item has been turned in the interim.

The present item management systems require that the lost item owner continue to query the item management system to determine if the lost item is found. This results in time consuming effort by personnel of an entity operating the item management system. Additionally, the repeated inquiries are time consuming for the lost item owner who must re-enter information relating the lost item. Furthermore, if the query is effected via a website portal, repeated inquiries tie up system resources.

Existing systems retain registration of lost items for a predetermined period of time after which notification is given that the period of time is expired. Personnel must then manually deregister the items from existing systems and proceed with evaluating how to dispose of items, i.e., destroy the items or attempt to sell the lost items. This is another time consuming process as data relating the nature of the lost items must be reviewed and then later applied to subsequent operations to dispose of the items.

New item management systems and methods are needed which facilitate the return of lost items to owners. In particular, a method and system for implementing the method is needed which reduces the time required by system operating personnel to process lost item inquiries. Further, a method and system is needed which reduces time of item owners which is consumed in attempting to find lost items. Still further, a system and method is needed which can effectively register and monitor lost items. Additionally, a system and method is needed which provides for efficient resolution of lost item status and disposal of unclaimed lost items.

### SUMMARY

An item management system and method is provided which provides for management of items to be stored and later retrieved and also lost items which are found by third parties and submitted to an operator of the item management system.

Accordingly, it is an optional object of the system and method of the present disclosure to provide an integrated application that covers processes of lost and found services and storage services.

It is a further optional object of the system and method of the present disclosure to provide support for administrating lost items and items left for storage in a lean, efficient manner.

It is another optional object of the system and method of the present disclosure to provide support for administration of storage areas and optimizing application of item categories to storage areas.

It is yet another optional object of the system and method of the present disclosure to provide support for processing of customer inquiries in order to optimize customer service regarding efficiency and quality with relation to repatriating lost items.

It is yet another optional object of the system and method of the present disclosure to provide support for identifying lost items which have remained unclaimed for a predetermined period of time and automatically transferring requisite data to a further system for effecting either sale of lost items or destruction of lost items.

Briefly stated, the present disclosure provides a lost item management system and method is provided for matching found items with lost item inquiries provided by customers. An item processing module is configured to accept and store item attributes of the found items as parts of item entries, wherein each of the item entries has a set of the item attributes. An inquiry processing module is configured to accept and store inquiry attributes, corresponding to attributes of the lost items, as parts of inquiry entries. An item matching module is configured to execute a match search comparing the item attributes of the item entries with the inquiry attributes of the inquiry entries and identify possible matches. A monitoring module is configured to actuate the item matching module, in accordance with a schedule, to execute the match search and notify the operator when possible matches are identified by the match search.

In an embodiment according to the above description, the lost item management system optionally further comprises a customer web frontend module configured to host a customer website providing input fields for accepting a subset of the set of inquiry attributes from customers as a customer inquiry entry storing the customer inquiry entry as one of the inquiry entries. The customer web frontend module is configured to trigger the item matching module to execute a match search using the customer inquiry entry and present a listing of possible matches in response to customer input. The customer web frontend module is configured to accept a selection of one of the possible matches presented to the customer and store a customer match indication associated with an inquiry entry and an item entry comprising the selected one of the possible matches.

In an embodiment according to any of the above described embodiments, the lost item management system optionally further comprises an embodiment having the match search being a weighted search which compares pairs of the item entries and the inquiry entries and produces search scores indicating correspondence of the compared pairs, and a search threshold value is used to determine if ones of the search scores are sufficient to indicate inclusion in the possible matches.

In an embodiment according to any of the above described embodiments, the lost item management system optionally further comprises an embodiment having a set of weights used to conduct the weighted search, and individual ones of the weights corresponding to ones of the inquiry attributes and ones of the item attributes, and the set of weights being attribute dependent.

In an embodiment according to any of the above described embodiments, the lost item management system optionally further comprises an embodiment having the item attributes and the inquiry attributes include category attributes having predefined settings from which a setting is selected and assigned to a corresponding one of the category attributes, and at least one of the category attributes is an attribute dependent attribute having associated predefined setting determined by settings of at least one other of the category attributes.

The above and other objects, features and advantages of the present invention will become apparent from the following description read in conjunction with the accompanying drawings, in which like reference numerals designate the same elements. The present invention is considered to include all functional combinations of the above described features and corresponding descriptions contained herein, and all combinations of further features described herein, and is not limited to the particular structural embodiments shown in the figures as examples. The scope and spirit of the present invention is considered to include modifications as may be made by those skilled in the art having the benefit of the present disclosure which substitute, for elements presented in the claims, devices or structures upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

In part, other aspects, features, benefits and advantages of the embodiments will be apparent with regard to the following description, appended claims and accompanying drawings where:

FIG. 1 is a high level block diagram of an system embodiment of an item management system;

FIG. 2 is a block diagram of an embodiment of operational modules of the item management system of FIG. 1;

FIG. 3 is a block diagram of an embodiment of a lost and found module of FIG. 2;

FIG. 4 is a block diagram of a lost luggage module of the embodiment of FIG. 2;

FIG. 5 is a site map of an embodiment of item registration dialogue operations of a lost and found backend module of FIG. 3;

FIG. 6 is a flowchart of an embodiment of a found item processing procedure;

FIG. 7 is a site map of an embodiment of item deregistration dialogue operations of the lost and found backend module of FIG. 3;

FIG. 8 is a site map of an embodiment of an inquiry entry dialogue operations of a lost and found backend module of FIG. 3;

FIG. 9 is a flowchart of an embodiment of an automatic search process of an item matching module of FIG. 3;

FIG. 10 is a flowchart of an embodiment of a lost and found method of operation of the present disclosure; and

FIG. 11 is a site map of an embodiment of a customer web frontend configuration which is accessible to customers via the internet/intranet and is implemented by a lost and found customer web frontend module of FIG. 3.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

It is noted that, as used in this specification and the appended claims, the singular forms “a,” “an,” and “the,” include plural referents unless expressly and unequivocally limited to one referent. Thus, for example, reference to “an inquiry” includes one, two, three or more inquiries.

Functions that are implemented via programming, either software, firmware, or hardware effectuated, are described as implemented by modules. Programmed devices such as computers, controllers, or portable versions thereof such as smart phones, are considered to be hardware configured to affect a stated function. The specific arrangements of modules presented are exemplary and not limiting. Functionalities implemented by a described module may optionally be implemented by a combination of modules with functions being subdivided in the combinations of modules, or the functionalities may optionally be included in another module as a sub function of the module. Such arrangements are considered to be within the scope and spirit of the present disclosure. Similarly, unless specifically excluded by claim language, reference to a module in claim language is considered to include the above noted alternative arrangements.

Reference will now be made in detail to various embodiments of the present disclosure, examples of which are illustrated in the accompanying drawings. While the embodiments of the present disclosure will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

The headings below are not meant to limit the disclosure in any way; embodiments under any one heading may be used in conjunction with embodiments under any other heading.

Tables present an order for the operations, however it is understood that unless subsequent operations require preceding operations, the order of the operations may be altered or operations omitted within the scope and spirit of this disclosure.

In addition to embodiments described in the above Summary, this disclosure further provides an embodiment according to any of the above described embodiments, wherein the lost item management system optionally further comprises an embodiment having the item attributes and the inquiry attributes include multipurpose attributes accepting free text entries. The item processing module presents category attribute dependent prompts for the multipurpose attributes.

In an embodiment according to any of the above described embodiments, wherein the lost item management system optionally further comprises an embodiment wherein the weighted search is a hybrid search requiring a match between at least one of the item attributes and a corresponding one of the inquiry attributes of the compared pair in order for the weighted search to be applied to the compared pair.

In an embodiment according to any of the above described embodiments, wherein the lost item management system optionally further comprises an embodiment wherein the weighted search includes the search threshold value being at least two search threshold values respectively corresponding to grades of the possible matches.

In an embodiment according to any of the above described embodiments, wherein the lost item management system optionally further comprises an embodiment wherein the search threshold value is attribute dependent.

In an embodiment according to any of the above described embodiments, wherein the lost item management system optionally further comprises an embodiment wherein an assignment threshold value is one of the at least two search threshold values, and the item matching module assigns an item entry to an inquiry entry of the compared pair in response to a search score of the compared pair equaling or exceeding the assignment threshold value, wherein the item matching module sets statuses of the compared pair to assigned and initiates delivering the item of the item entry to the customer.

In an embodiment according to any of the above described embodiments, wherein the lost item management system optionally further comprises an embodiment wherein the item matching module updates a last search date attribute of the inquiry attributes to indicate a date of the match search, and, when executing subsequent match search for a given one of the inquiry entries, reads the last search date attribute and limits the match search to ones of the item entries entered subsequent to the read last search date.

In an embodiment according to any of the above described embodiments, wherein the lost item management system optionally further comprises an embodiment further comprising a lost and found category module configured to maintain designations of the inquiry attributes and the item attributes by accepting input from the operator effecting at least one of deletion, addition, or modification of the designations.

In an embodiment according to any of the above described embodiments, wherein the lost item management system optionally further comprises an embodiment wherein the lost and found category module is further configured to maintain category attribute dependent prompts by accepting input from the operator effecting at least one of deletion, addition, or modification of the category attribute dependent prompts.

In an embodiment according to any of the above described embodiments, wherein the lost item management system optionally further comprises an embodiment wherein the item matching module updates a last search date attribute of the inquiry attributes to indicate a date of the match search, and, when executing subsequent match search for a given one of the inquiry entries, reads the last search date attribute and limits the match search to ones of the item entries entered subsequent to the read last search date.

In an embodiment according to any of the above described embodiments, wherein the lost item management system optionally further comprises an embodiment further comprising an item deregistration module configured to set an item attribute to expired in response to determining a predetermined time period has passed without the item entry being assigned one of the inquiry entries. In response to determining the item is expired the item deregistration module assigns a storage location to the item entry designated for an auction partner, and prints auction processing documents.

In an embodiment according to any of the above described embodiments, wherein the lost item management system optionally further comprises an embodiment further comprising an item deregistration module configured to set an item attribute to expired in response to determining a predetermined time period has passed without the item entry being assigned one of the inquiry entries, and in response to determining the item is expired the item deregistration module removes the item from the item entries and assigns the item to one of charity, gross-sale, online sale, destruction, or operator operations based on an estimated value of the item.

### DEFINITIONS

Table 1 below provides a listing of definitions of terms used throughout this disclosure which will apply to the terms used unless a term is clearly is in a manner contrary to the definition presented below.

| Term | Explanation |
|---|---|
| Autocomplete | When entering text into a field, the system displays lists of text terms |
| | which at least partially match the text entered for a user to select as input |
| | instead of typing out the entire text to be entered in the field. |
| Back office | Refers to access modes to the system which are not available to customers |
| | and only accessible to Operator and the contractor partners or |
| | subcontractor. |
| Bin location | A bin location is a location within a storage area. The combination of a |
| | storage area and a bin location is unique. |
| c-matched | A matching of a registered found item by a customer to an inquiry |
| | submitted by the customer via a web portal |
| Cat # | Refers to a specific category descriptor. For example, Cat 1 may be “Cell |
| | Phone”, Cat 2 may be “Laptop”. |
| Click | Refers to selecting by clicking a mouse button |
| Contracted | A contracted partner is a company that has been contracted by operator for |
| Partner | L&F services. Whenever items are found by the partner's personnel they |
| | are delivered to operator periodically in batches. Operator charges based |
| | on a fixed rate per item. |
| Customer | A customer is an owner of an item. L&F Customer: The L&F customer is |
| | the person who has lost an item and starts an inquiry. Left luggage |
| | customer: The LL customer is the person or company who or leaves items |
| | to store it for him/them. A customer can create a profile, search the |
| | database and make an inquiry. |
| Customer | A device, such as a computer or smart phone, operated by a customer to |
| Platform | access the IMS. |
| Dialogue | Refers a presentation on a display of information and optionally |
| | hyperlinks, or buttons for effecting operations including, for example and |
| | not limitation, data entry and modification, data sorting, and operation |
| | initiation |
| Dialogue | Refers to an operating module which presents a dialogue, and also a |
| operation | display of the dialogue. |
| Field User | A Field User will have access to the web and mobile applications with the |
| | ability to manage their profile, enter and update items into inventory, and |
| | search items. A field user could be an airport staffer, security officer, |
| | cleaning office or an operator field worker, as examples. |
| Finder | The Finder is the contracted partner (or his subcontractor) or the private |
| | person who has found a lost item and hands it into operator. |
| IMS | Item Management System. |
| Inquiry | L&F: An inquiry is an order received from a customer, who has lost an |
| | item and is seeking to reclaim the item if found. |
| Item | An item is a piece of property. L&F Item: An item is a piece of property |
| | lost by an owner and handed in to operator by a finder. Left luggage Item: |
| | An item is a piece of property left by an owner to be stored for him until |
| | he picks it up. |
| L&F (“Lost & | “L&F” (as well as “Lost & Found”) is the term for operator's lost property |
| Found”) | office/services. Operator receives items from contracted partners (such as |
| | Airlines or the Airport operating company) or their subcontractors (such |
| | as security companies, cleaning companies, airport restaurants) and from |
| | private persons. |
| Left luggage | “Left luggage” is the term for customer storage services. The left luggage |
| (“LL”) | customer leaves items at the operator counter and appoints the date and |
| | time he is planning to pick them up. |
| Module | A device in the form of a programmed computer or, dedicated |
| | programmed device, other electronic device, or combination thereof |
| | configured to effect a function or variety of functions. A module is also |
| | computer programing code directing operation of a module. |
| Operator | The person or entity which operates the item management system by |
| | administering the data and web servers and entering into contracts with |
| | contractors. |
| Operator | An operator administrator can perform all the functions listed in the field |
| Administrator | user description, as well as create and manage users, and view item |
| | statuses. |
| Revenue | Fees collected based on the category and numbers of item and the 24- |
| | hours periods the items are to be stored a price is calculated. The customer |
| | in general pays in advance. |
| Selecting | Unless context indicates otherwise, refers to the operation of selecting an |
| | object (i.e., an item, an inquiry, a box, etc.) in a dialogue display by |
| | highlighting or placing a cursor on the object and using a mouse left click |
| | (or equivalent keyboard or other operation) to activate a further dialogue |
| | display associated with the object |
| Storage area | A storage area is a storage location such as a rack or a shelf in a rack or a |
| | part of a shelf. The storage areas are defined and used dependent on the |
| | categories of the items. For instance there are dedicated storage areas for |
| | clothes, electronic items, identity cards and items of high value. |
| Subcontractor | A Subcontractor is a company subcontracted by a contracted partner for |
| | L&F services. |
| | Subcontractors are not being charged as the contracted partner is in charge |
| | for paying operator. |
| System | The administrator will have full and complete access to the application, to |
| Administrator | create and manage users, monitor transactions (where applicable), and |
| | download log files, as examples. |
| User | Refers to a person who is either the Operator, a contactor partner, or sub- |
| | contractor and not a customer or inquiry customer, unless otherwise |
| | specified. |
| User Platform | A device such as a computer or smart phone operated by a contractor to |
| | access the IMS. |

### System Architecture.

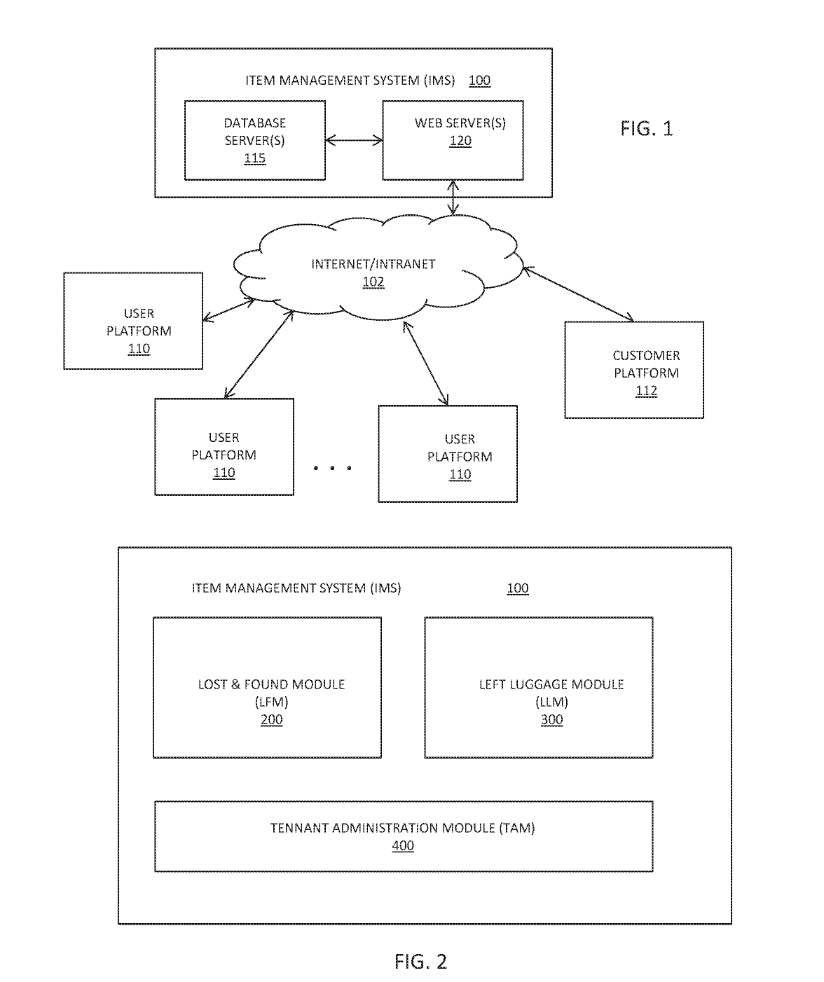

Referring to FIGS. 1 and 2, an item management system (IMS) 100 resides on a webserver 120 and a database server 115. While shown independent of each other, the web server 120 and the database server 115 may be consolidated on a single server device or distributed over more server devices, i.e., computers and associated digital storage. The item management system 100 is controlled by an operator which may either be a person or an entity that maintains the IMS 100. The operator may operate the IMS 100 by itself or engage contractors that access the IMS to enter and retrieve information and effect other operations.

The IMS 100 is optionally configured as a web-enabled (Internet) application that uses a relational database that is accessed via a browser optionally using a TCP/IP connection over the Internet. As embodied as an Internet application, the IMS 100 resides on a computer, in the example of this disclosure, the operator's computer(s), for example, the web server(s) 120, and is accessed via a browser over the Internet or a corporate intranet 102. The operator and contractor access the IMS 100 via user platforms 110 which are embodied as a type of computer device, such as a PC or a smart phone, which is capable of interfacing with the IMS 100 via the internet 102 or an intranet. The IMS 100 has three main modules which are a lost and found module 200, a left luggage module 300, and a tenant administration module (TAM) 400, operations of which are detailed below.

Internet applications access databases or other static information which is displayed on a browser. The IMS 100 interface is optionally graphical and pages are navigated using hyper-links. Hyper-links are a word or phrase that is highlighted and underlined when displayed in a browser. When clicked on, the hyperlink directs one to another section of the application, i.e., a dialogue/operation. or to another application.

In an optional embodiment, no piece of the application is installed on the user's computer; it is just accessed via the browser on a per-demand basis. An advantage of this solution is that when the application is updated, the users will instantly be accessing the most up to date version. This reduces maintenance and support. Users are always running the latest version of the application due to the fact that it only resides on the server.

Alternatively, the IMS 100 is optionally configured to be installed and operated on client systems with or without use of a browser for accessing dialogue displays of the system. In other words, the IMS 100 is optionally configured to run on user platforms and generate dialogues for accepting user input. While described herein as an Internet application, it is understood that this disclosure also includes the IMS 100 being operated as an installation on user platforms with database storage being implemented on one or more user platforms with updates to the database storage being synchronized.

The basic architecture of the IMS 100 includes active components, or modules, static components, or modules, and a storage component, or module. An active component is an executable or scripted functions used to process user or customer interaction. Static components include image files, which provide graphics, and web pages. Web pages are preferably written using Hyper Text Markup Language or HTML5, and it is through the use of HTML5, with responsive CSS, that results of user/customer requests are displayed in any size browser. The storage components are optionally embodied as databases which contain the information used by the IMS 100 to respond to user requests.

Users access the IMS 100 using a web browser. By entering a URL address, the browser sends a request for information via the Internet/Intranet connection to the IMS 100 residing on the web server 120. The IMS 100 processes requests, accesses the database for information if necessary, and returns the new information to the browser for display in an HTML page. User access to the IMS 100 is controlled by login and password verification.

The lost and found module 200 and the left luggage module 300 optionally present a responsive web interface, which means a GUI that has the ability to render on a desktop, tablet or mobile browser, as well as a mobile application component, to aid the operator staff in executing the process of logging (registering) items into the system, for example attaching items photos and/or scanning security tags. Information is optionally stored in any of Hyper Text Markup Language (HTML) text files, JavaScript (JS) files and Portable Network Graphics (PNG) files. The IMS 100 is navigated using hyper-links (which appear as a word or phrase that is highlighted and underlined) or via navigational buttons. When clicked, the link brings up another page of the IMS 100.

### Lost and Found Module (LFM) Architecture.

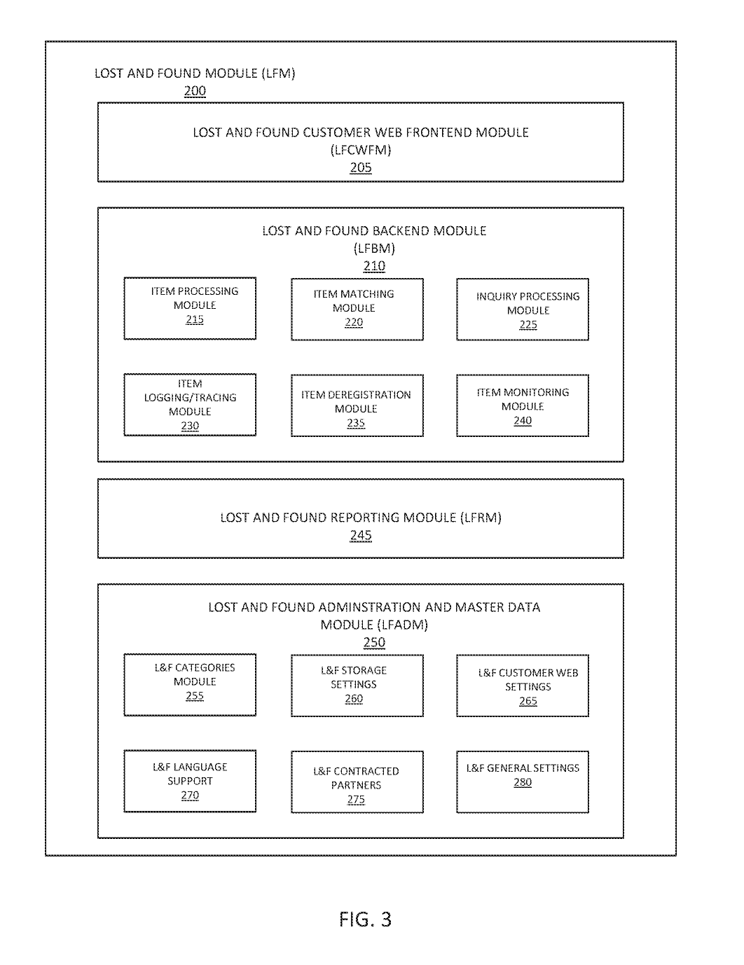

Referring to FIG. 3, the lost and found module (LFM) 200 has a lost and found customer frontend module 205 which operates to present a customer website permitting access to functions of the IMS 100. A lost and found customer web frontend module (LFCWFM) operates to host the customer website to allow limited customer access to the IMS 100 for purposes of any of entering an inquiry, suggesting a matching item to an inquiry, and review of registered found items. A lost and found backend module (LFBM) 210 operates to, inter alia, accept lost item inquiries and to match the inquiries with lost items registered in the IMS 100. The LFCCBM 210 optionally includes an item processing module 215, an item matching module 220, an inquiry processing module 225, an item logging module 230, an item deregistration module 235, and an item monitoring module 240. A lost and found reporting module 245 operates to provide reports identifying statuses of lost property items registered in the IMS 100, and statuses of inquiries entered in the IMS 100. A lost and found administration and data module (LFADM) 250 operates to store and modify system attributes such as L&F categories module 255, L&F storage setting 260, L&F customer web settings 265, L&F language support 270, L&F contract partner settings 275, and L&F general settings 280. Further details of operation of the LFM 200 are discussed below.

### Left Luggage Module (LLM) Architecture and Operation.

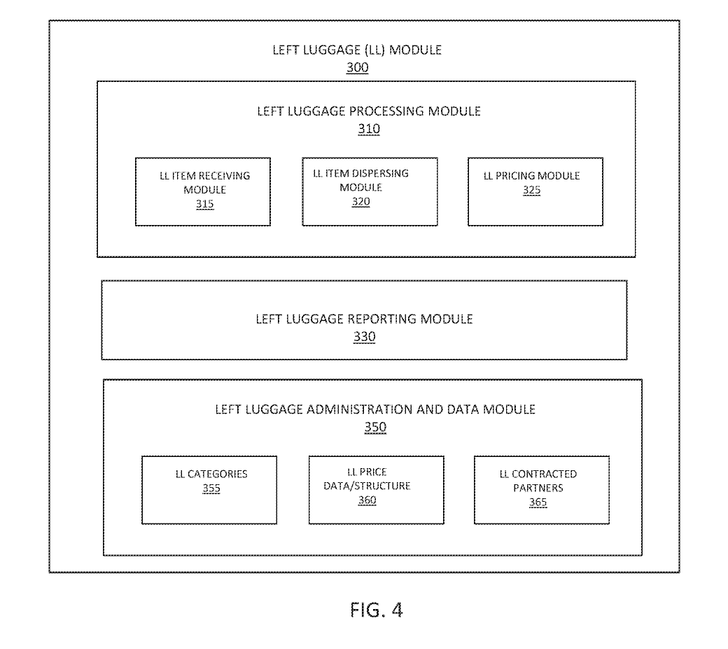

Referring to FIG. 4, the left luggage module (LLM) 200 optionally has a left luggage processing module (LLPM) 310 which operates to, inter alia, accept left luggage via an LL item processing module 315, an LL dispersing module 325, and an LL pricing module 325. The LLM 200 functions to accept registration of item (e.g. luggage) by a customer wishing to have the item stored until the item is reclaimed by the customer. The left luggage operation is similar to the lost luggage operation described below in that items are registered in the IMS 100, records are maintained of the registration and may be accessed by users and updated to reflect the status of items. Updates include changes, such as when items are reclaimed and when items are not reclaimed after a customer designated storage period has past.

A left luggage reporting module (LLRM) 330 operates to provide reports identifying statuses of LL items registered in the IMS 100. The LLADM 350 operates to effect and modify operations regarding system attributes such as LL categories 355, LL price data/structure settings 360, and LL contract partner settings 365. Dynamic information is maintained in a database comprising the LFADM 250, LLADM 350, and TAM 400.

Since the items and the owners of the items are known, left luggage operation do not require matching operations and procedures discussed below for the lost and found operations discussed below. Accordingly, further discussion of the LLM 200 operation is curtailed as operations such as registration of left luggage items and claiming of left luggage items are considered substantially redundant to like operations of the LFM 200 discussed below.

### Lost and Found Module Operation—Found Item Registration.

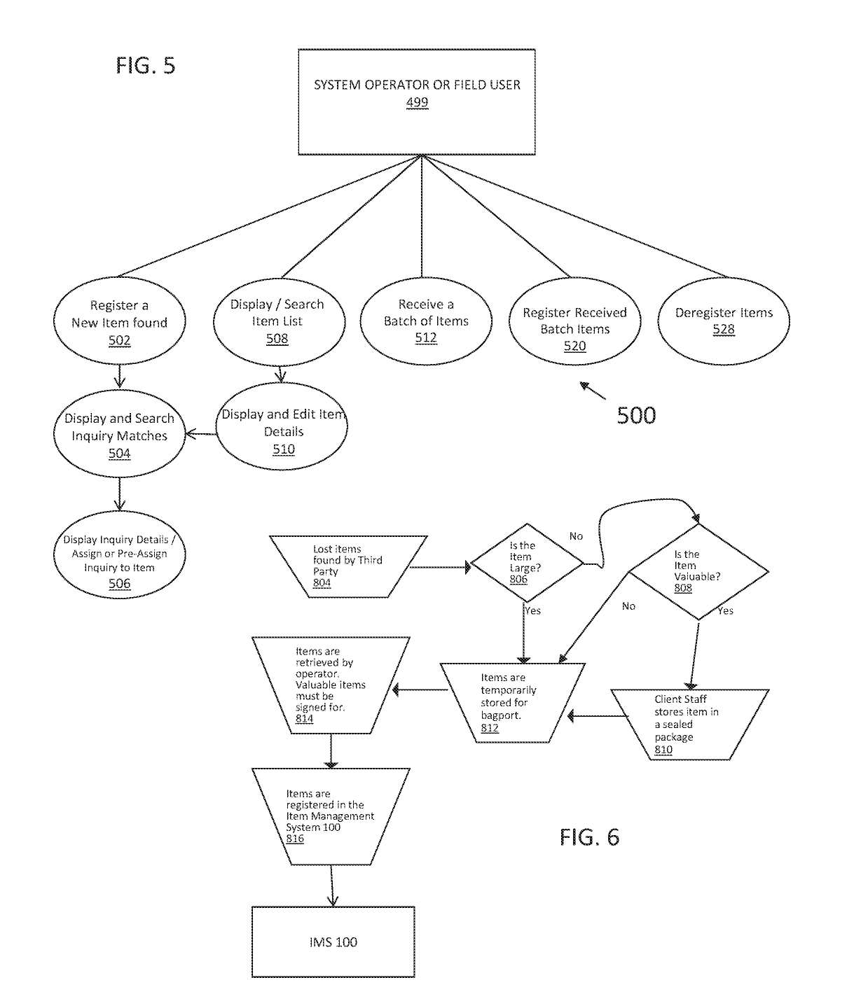

Referring to FIG. 5, an overview of lost and found dialogue operations conducted by the system operator 499 or a field user includes, but is not limited to, operations effected using a registering a new item dialogue operation 502 which has been found, a displaying and/or searching an item list dialogue operation 508 for previously registered found items, receiving a receive batch of items dialogue operation 512 for items which have been found, a registering received batch items dialogue operation 520, and a deregistering items 528 dialogue operation.

Referring to FIG. 6, a flowchart of manual operations performed either by a client user or the operator 499 details operations performed when an item is found. Operation 804 is executed by third parties which find items and present them to a lost and found office. It is first decided if the item is large, for example a suit case, in operation 806. If the item is large the item is temporarily stored for the operator in operation 812. If the item is determined to be valuable, such as a watch or jewelry, in operation 808. it is sealed in a package in operation 810. If the item is not considered valuable it is directly temporarily stored for the operator in storing operation 812. The operator periodically retrieves stored items, signing for valuable items, in operation 814. The operator, or a client user, then registers the item in the IMS 100.

Operation of the registering dialogue operation 502 for registering a found item, shown in FIG. 5, is detailed in Table 2 below in sub-operations 2-2 through 2-8. Dialogue operation 504 of FIG. 5, searching for and displaying possible matches is effected by sub-operation 2-9 while the assigning/pre-assigning dialogue operation 506 is effected by sub-operations 2-10 through 2-13.

TABLE 2
FOUND ITEM REGISTRATION PROCEDURE

| NO. | SUB-OPERATION | EXECUTOR | DESCRIPTION |
|---|---|---|---|
| 2-1 | Find and | Finder | Event: A finder (may be an organisation or |
| | submit a lost | | a private person) finds a single or few lost |
| | item | | items and hands it in at the Operator on site |
| | | | office. |
| 2-2 | Enter Fixed | Operator/Field | The item is entered into the IMS 100. The |
| | attributes | User - IMS 100 | user selects and enters a number of fixed |
| | | | attributes used for all kinds of items. |
| 2-3 | Enter | Operator/Field | Based on a set of categories (organized |
| | multipurpose | User - IMS 100 | within 3 Levels) a set of individual |
| | attributes | | multipurpose attributes are entered into the |
| | | | IMS 100. |
| 2-4 | Generating a | IMS 100 | The IMS 100 generates and suggests a |
| | stock area and | | stock area and bin location. |
| | bin location | | |
| 2-5 | Selecting a | Operator/Field | The user is able to select a suggested |
| | stock area | User - IMS 100 | overflow area instead of the suggested |
| | | | original area. |
| 2-56 | Printing the | Operator/Field | The user is able to direct the IMS 100 to |
| | barcode | User - IMS 100 | print a barcode label. |
| 2-7 | Printing a | Operator/Field | The user is able to direct the IMS 100 to |
| | finder's | User - IMS 100 | print a finder's receipt. |
| | receipt | | |
| 2-8 | Printing both | Operator/Field | The user is able to direct the IMS 100 to |
| | barcode and | User - IMS 100 | print both a barcode label and finder's |
| | finder's | | receipt. |
| | receipt | | |
| 2-9 | Display/ | Operator/Field | The IMS 100 optionally displays a list of |
| | Search | User - IMS 100 | possibly matching inquiries. The user is |
| | matching | | able to filter and sort the list. |
| | inquiries | | |
| 2-10 | Display details | Operator/Field | The user selects an inquiry from the list of |
| | of an inquiry | User - IMS 100 | possibly matching inquiries and the IMS |
| | | | 100 displays the inquiry details. |
| 2-11 | Assign inquiry | Operator/Field | On an inquiry details dialogue, the user |
| | to the item | User - IMS 100 | directs the IMS 100 to assign the item to |
| | | | the selected inquiry IF the item matches |
| | | | the item identified in the inquiry. |
| 2-12 | Send an email | IMS 100 | On the assignment of the matching inquiry |
| | to customer on | | a customer who submitted the inquiry is |
| | assigning an | | sent an email sent automatically by the |
| | inquiry | | IMS 100 in response to the assignment. |
| 2-13 | Pre-Assign | Operator/Field | On the inquiry details dialogue the user |
| | inquiry to the | User - IMS 100 | directs the IMS 100 to pre-assign the item |
| | item | | to the selected inquiry, IF the item is |
| | | | probably the property of a customer who |
| | | | submitted the inquiry. |

The registering of a new found item includes the IMS 100 accepting and storing in the database server 115 fixed attributes and multipurpose attributes of the new found item optionally comprising any combination or all of the attributes presented in TABLE 2A below.

TABLE 2A
FOUND ITEM REGISTRATION ATTRIBUTES

| ATTRIBUTE | DESCRIPTION | INPUT |
|---|---|---|
| Item ID | Generated by the IMS 100 8 Digits | IMS 100-generated/ |
| | | Display only |
| Item State | Generated by IMS 100. Set to “registered” | IMS 100-generated/ |
| | on registering the item. | Display only |
| User | Generated by IMS 100. Name of the user | IMS 100-generated/ |
| | logged into the IMS 100 | Display only |
| Box ID | Generated by IMS 100 on deregistration of | IMS 100-generated/ |
| | items . . . Set to empty field on registering an | Display only |
| | item . . . Clicking on the ID opens the box | |
| | details. | |
| Matched | Generated by the IMS 100 . . . Set to empty | IMS 100-generated/ |
| inquiry ID | field on registering an item . . . Clicking on | Display only |
| | the ID opens the inquiry details. | |
| Date/Time of | The date/time the item is handed in - thus | IMS 100-generated/ |
| registration | the official start of the 3 month -. period | Display only |
| | until the item belongs to property of | |
| | Operator . . . This attribute must not be | |
| | changed after registering an item. | |
| Date/Time | The date/time the item has been found by | Default:. Equals |
| found | the finder. The date may vary from the date | Date/time of registration . . . |
| | the item is handed in (registration date) and | May be overwritten by |
| | is used for searching matches to inquiries. | user (calendar widget, |
| | | time set to “00:00”) |
| User latest | User name of the logged in | IMS 100-generated/ |
| change | | |
| | user who made the latest change . . . Equals | Display only |
| | User on registering a new item. | |
| Date/Time | Generated by the IMS 100 . . . The date/time | IMS 100-generated/ |
| latest change | of the last change made to the item. Equals | Display only |
| | Date/Time of registration on registering a | |
| | new item. | |
| Category 1 | Main Category | Drop down. with |
| | | autocomplete. |
| Category 2 | Sub Category (only Cat 2s that are assigned | Drop down. with |
| | to Cat 1 are possible) | autocomplete. |
| Category 3 | Sub Category (only Cat 3s that are assigned | Drop down. with |
| | to Cat 2 are possible) | autocomplete. |
| Color | Selection of administered colors (may be | Drop down. with |
| | “Other”) | autocomplete. |

| | | |
|---|---|---|
| Found where | Selection of administered locations | Drop down. with |
| | (may be “Other”). Examples:. | autocomplete. |
| | Terminal 1. Airline X. Security | |
| | area | |
| Found where | Location details . . . Mandatory if | Free text |
| details | location is not provided in “Found | |
| | where” (thus “Other”) . . . Examples:. | |
| | Flight Number. Seat XXX | |

| | | |
|---|---|---|
| Storage area | Generated by the IMS 100 on the input of | 3 Characters |
| | category 3. Can be overwritten by the user | |
| | by selecting the assigned overflow area (if | |
| | available) | |
| bin location | Generated by the IMS 100 on the input of | 5 Digits |
| | category 3. Is regenerated if the user selects | |
| | the overflow area. | |
| L + F pick up fee | Generated by the IMS 100. Generated | IMS 100 generated. May |
| | depending on the value of category 2 . . . | be overwritten by the user |
| | Whenever the category 2 is changed, the | |
| | fee must be updated . . . May be overwritten | |
| | by the user. | |
| Special Marks | Special marks (such as stickers, scratches | Free text |
| | etc.) may be entered here. | |
| Notes | Additional item information may be entered | Free text |
| | here | |
| Staff notes | Space for internal staff information. For | Free text |
| | example information about ongoing | |
| | communication, To Dos etc. | |

Returning to FIG. 5, the Operator or a field user 499 may optionally display a list of found items in dialogue operation 508. Found items are displayed within a list dialogue. The list optionally can be sorted (ascending or descending) by the displayed fields (one field at a time). The list can be filtered by the user. A free text search on items is optionally provided for. In dialogue operation 510 the user may select an item from the displayed list effect editing of item details. Alternatively, the user may select an item and proceed to dialogue operation 504 wherein a search is made for an inquiry matching the selected item. These operations are performed by the item processing module 215 depicted in FIG. 3.

The operations detailed in Table 2 and FIG. 5, are executed by the Operator or a Field User at an office of the operator or an office of the field user when a finder submits a found item. It is further possible to execute the above procedure via a portable device such as a tablet computer or a smart phone while in the field.

A batch receipt dialogue operation 512 is used when a batch of found items is received from a contracted partner. Since there may be many items in the batch, it is desired that entry of the batch be expedited by initially pre-registering the batch items into the IMS 100 using a set of information reduced from that used in the registering dialogue operation 502 for a single found item. The sub-operations of the batch receipt dialogue

TABLE 3
BATCH ITEMS PRE-REGISTRATION PROCEDURE

| NO. | SUB-OPERATION | EXECUTOR | DESCRIPTION |
|---|---|---|---|
| 3-1 | Receive a | Operator/Field | Event: A contracted partner or his subcontractor |
| | batch of items | User - IMS 100 | hands in a batch of items that are found. |
| 3.2 | Create a new | Operator/Field | A new batch is created. The batch is defined by |

| | | | |
|---|---|---|---|
| batch | User - IMS 100 | 1. | A system-generated batch ID |
| | | 2. | Selection of the contracted partner (drop- |

| | down) |
|---|---|
| 3. | Selection of the subcontractor (drop-down, |
| | optional) |
| 4. | Personal ID of the delivering Person (free |

text, optional)

| | | | |
|---|---|---|---|
| 3-3 | Add items to | Operator/Field | Items are then added to the batch by adding a new |
| | batch | User - IMS 100 | item-row and entering the reduced set of attributes. |
| 3-4 | Close the batch | Operator/Field | After closing the batch the details of the batch must |
| | | User - IMS 100 | not be changed anymore. |
| 3-5 | Print batch | Operator/Field | After having entered all items of the batch a batch |
| | receipt | User - IMS 100 | receipt is printed to be signed by Operator and |
| | | | handed out to the partner. |

operation 512 are detailed in Table 3 below and executed by the item processing module 215 of FIG. 3.

In operation 3-1 a batch of found items is received by either the Operator, contracted partner, or subcontractor thereof. This is common when a contracted partner periodically uses the IMS 100 to return found items and in the interim collects the found items. A new batch creation operation 3-2 is next executed wherein the IMS 100 generates a batch ID, and the executor enters the contracted partner, sub-contractor if applicable, and an ID of the person presenting the batch items. Next, an item entry operation 3-3 is executed for each item presented. The item entry operation entails entering a reduced set of information from what is normally entered when a single item is registered. This process is termed pre-registration because registration must later be completed by adding attributes of the found item. Upon completing entry of the information for a given item, the information is then saved to the database server 115 and the item processing module 215 of the IMS 100 generates a unique item ID, date and time of the pre-registration based on the time zone of the tenant, i.e., contracted partner or subcontractor thereof, and the item's state is set to “received” rather than “registered.” The information stored in the pre-registration operation is presented in Table 3a below.

TABLE 3A
FOUND ITEM BATCH PRE-REGISTRATION ATTRIBUTES

| ATTRIBUTE | DESCRIPTION | INPUT |
|---|---|---|
| Item ID | Generated by the IMS 100 - 8-digits | IMS 100- |
| | | generated . . . |
| | | Displayed. |
| Item State | Generated by the IMS 100. Set to “received.” | IMS 100- |
| | | generated . . . Not |
| | | displayed but |
| | | saved |
| User | Generated by IMS 100. Name of the user logged | IMS 100- |
| | into the IMS 100 | generated . . . Not |
| | | displayed but |
| | | saved |
| Box ID | Generated by the IMS 100. Set to empty field on | IMS 100- |
| | registering an item. | generated . . . Not |
| | | displayed but |
| | | saved |
| Matched | Generated by the IMS 100. Set to empty field on | Not displayed but |
| inquiry ID | registering an item. | saved |
| Date/Time of | . The date/time the item is handed in - thus the | Not displayed but |
| registration | official start of the 3 month -period until the item | saved |
| | belongs to property of Operator/Field User - IMS | |
| | 100. This attribute must not be changed after | |
| | registering an item | |
| Date/Time | The date/time the item has been found by the finder. | Default: Equals |
| found | The date may vary from the date the item is handed | Date/time of |
| | in (registration date) and is used for searching | registration. |
| | matches to inquiries. | Not displayed but |
| | | saved |
| User latest | User name of the logged in user who made the latest | IMS 100- |
| change | change. Equals User on registering a new item. | generated. Not |
| | | displayed but |
| | | saved |
| Date/Time | Generated by the IMS 100. The date/time of the last | IMS 100- |
| latest change | change made to the item. Equals Date/Time of | generated. Not |
| | registration on registering a new item. | displayed but |
| | | saved |
| Category 1 | Main Category | Drop down with |
| | | autocomplete |
| Category 2 | Sub Category (only Cat 2s that are assigned to Cat 1 | Drop down with |
| | are possible) | autocomplete |
| Category 3 | Sub Category (only Cat 3s that are assigned to Cat 2 | Drop down with |
| | are possible) | autocomplete |
| Found where | Selection of administered locations (may be | Drop down with |
| | “Other”) | autocomplete. |
| | Examples: | |

Terminal 1
Airline X
Security area
Other

| | | |
|---|---|---|
| Note | Additional notes | Free text |

Once all items are pre-registered, a batch close operation 3-4 is executed wherein data for the batch is stored in the database server 115. Finally, the batch receipt print operation 3-1 prints a receipt that is presented to the batch presenting party.

Registering of batch items dialogue operation 520 of FIG. 5 is accomplished by the sub operations of TABLE 4 presented below and is effectuated via the item processing module 215 of FIG. 3.

TABLE 4
BATCH ITEMS REGISTRATION PROCEDURE

| NO. | SUB-OPERATION | EXECUTOR | DESCRIPTION |
|---|---|---|---|
| 4-1 | Register | Operator/Field | Items that have been pre-registered within a |
| | received | User | batch have to be completed later by adding |
| | batch items | | attributes and are then registered. |
| 4-2 | Display list of | Operator/Field | Batches are displayed within a list dialogue. |
| | existing | User - IMS 100 | |
| | batches | | |
| 4-3 | Display batch | Operator/Field | By selecting a batch, the batch details are |
| | details | User - IMS 100 | displayed. The items of a batch are displayed |
| | | | as a list within this dialogue. |
| 4-4 | Register | | By selecting an item of the batch the item |
| | received batch | | details are displayed. The item is completed by |
| | items | | adding attributes and saved. It changes its state |
| | | | to “registered”. |
| 4-5 | Generate | IMS 100 | The IMS 100 reviews available storage |
| | Storage | | facilities and determines next most efficient |
| | Information | | storage position and assigns storage area and |
| | | | bin location. |
| 4-6 | Generate Bar | IMS 100 | The IMS 100 generates and prints a barcode |
| | Code | | label using this ID on a dedicated barcode |
| | | | printer |

In sub-operation 4-1 the user obtains the batch of items to be registered. In sub-operation 4-2 the user enters the batch registration mode and the IMS 100 displays a list of batches which have been pre-registered. In sub-operation 4-3 the user selects the appropriate batch from the and the items of the batch are display in a list so that a given item to be registered can be selected from the list and the information associated with the item displayed and additional attribute information for the item is added. Sub-operation 4-4 for registering pre-registered items proceeds as related in registering dialogue operation 502, shown in FIG. 5, and discussed above with the exception that information previously completed in the receipt of batch items dialogue operation 512 is already included and only items of TABLE 2A which are not completed in the pre-registration need be input.

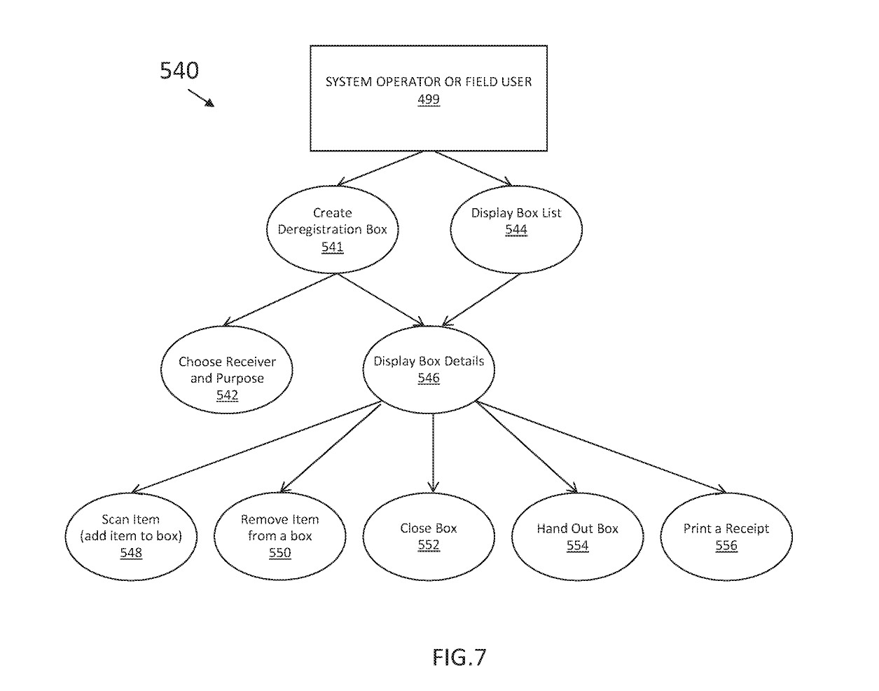

Referring to FIG. 7, a deregistration dialogue operation tree 540 is shown which illustrates steps of a deregistration operation of FIG. 5. The system operator or field user deregisters items if the item is returned to its owner or the item has been registered for a predetermined period of time without being returned, and hence is considered to be “expired.”. TABLE 5 below presented the sub operations effectuated during the deregistration dialogue operation 528. The item deregistration module 235 of FIG. 5 functions to effect the sub-operations of TABLE 5. The item monitoring module 240 automatically reviews the registered items periodically, based on a predetermined period, and generates a list of items to be deregistered.

TABLE 5
DEREGISTRATION PROCEDURE

| NO. | SUB-OPERATION | EXECUTOR | DESCRIPTION |
|---|---|---|---|
| 5-1 | Deregister | Operator/Field | Event: Items that are expired are |
| | items | User - IMS 100 | determined and listed by the IMS 100 and |
| | | | retrieved for deregistration. |
| 5-2 | Create a | Operator/Field | A new deregistration box is created. |
| | deregistration | User - IMS 100 | |
| | box | | |
| 5-3 | Adding items to | Operator/Field | Items are added to the deregistration box |
| | a box | User - IMS 100 | by scanning their barcode label. |
| 5-4 | Close a box | Operator/Field | The box state is set to “closed”. Items |
| | | User - IMS 100 | cannot be assigned to the box or removed |
| | | | from a box anymore. |
| 5-5 | Hand out a box | Operator/Field | The box is handed out or sent to a receiver. |
| | | User - IMS 100 | |
| 5-6 | Print a | Operator/Field | On handing out a box a receipt is printed to |
| | receiver's | User - IMS 100 | be signed by the receiver for Operator files. |
| | receipt | | |
| 5-7 | Display box list | Operator/Field | The boxes are displayed within a list sorted |
| | | User - IMS 100 | by creation date. By selecting a box the box |
| | | | details are displayed. |
| 5-8 | Remove an item | Operator/Field | Items can be removed from a box by |
| | from a box | User - IMS 100 | issuing a remove control on the Display |
| | | | and Edit box dialogue. |
| 5-9 | Display and edit | Operator/Field | The display of the box details contains a |
| | box details | User - IMS 100 | header including the boxes attributes and |
| | | | the list of assigned items. |

In sub-operation 5-2 a deregistration box is created in the IMS 100 by entry of the attributes listed below in TABLE 5A in conjunction with the IMS 100 automatically generating information as set forth in TABLE 5A. Once a box is created, the IMS 100 optionally proceeds to display a list of box details for review in dialogue operation 546 of FIG. 7. In a purpose assigning dialogue operation 542 the user decides the purpose of the deregistration by selection of a purpose from a drop down list optionally including but not limited to charity, authority, gross-sale, online sale, auction, destruction, or operations of the Operator.

TABLE 5A
DEREGISTRATTON BOX ATTRIBUTES

| ATTRIBUTE | DESCRIPTION | INPUT |
|---|---|---|
| Box ID | Generated by IMS 100 8 digits | IMS 100- |
| | | generated/ |
| | | Display only |
| Box state | Generated by IMS 100 Set to | Displayed |
| | “open” | |
| User of creation | Generated by IMS 100 Name of the | IMS 100- |
| | user logged into the IMS 100 | generated/ |
| | | Display only |
| Date/Time | The date/time of the creation | IMS 100- |
| of creation | | generated |

| | | |
|---|---|---|
| Purpose | Selection of a purpose Examples: | Drop down |
| | Charity, Authority, Gross-sale, | |
| | Online Sale, Destruction, | |
| | operations | |

| | | |
|---|---|---|
| User latest | User name of the logged in user who | IMS 100- |
| change | made the latest change. Equals User | generated/ |
| | on creating a new box. | Display only |
| Date/Time | Generated by the IMS 100. The | IMS 100- |
| latest change | date/time of the last change made to | generated/ |
| | the item. Equals Date/Time of | Display only |
| | registration on registering a new item. | |
| Receiving | Selection of a receiving company | Drop down |
| company | | |
| Note | Text note | Free text |

Following creation of the deregistration box, items are added to the deregistration box in sub-operation 5-3 by effecting a scan dialogue operation 548, shown in FIG. 7, wherein an item's barcode, which was applied to the item when it was registered, is read and the IMS 100 proceeds to associated the item's data with the deregistration box which has just been created. The item then appears as a row within the box details and can be checked by the user. The items state is set by the IMS 100 to “ready for deregistration”, the previous items state has to be remembered by the IMS 100 for the case the item is detached from the box in the future. The item row contains the following information: Item ID, Date registered, Category 1, Category 2, Category 3, Color, Multipurpose 1, and Items note. An item may be subsequently detached, or removed, from a box in removal dialogue operation 550 as long as the box state is “open.” Once all items are added, the box close dialogue operation 552, also related above as sub-operation 5-4, is effected by the IMS 100 setting a state of the box to “closed” after which items can no longer be added or removed from the deregistration box. The hand out the box dialogue operation 554, also sub-operation 5-5, is manually done by the Operator 499 wherein the box is turned over to a receiver associated with the selected purpose of the box. A print receipt dialogue operation 556, also sub-operation 5-6, is next effected. The display box list dialogue operation 544, also sub-operation 5-7, may be accessed by the Operator or field user 499 wherein the IMS 100 displays a listing of deregistration boxes for review. Any box may be selected from the list to produce a display of the box details in dialogue operation 546 from which further operations on the box may be conducted.

The item deregistration module 235 includes processing for sending deregistered items to a contracted auction entity, auction partners, for auctioning. There is a process that dictates that items should be dispatched after a defined period of time. The term dispatched is defined as processing items of value for auction and items of no (or little) value will be donated or disposed. The System Administrator sets item expiration dates (system wide) each day the item monitoring module will query the inventory for items that have expired. The report will list the items details including bin location and description, and item value (estimated). Within the Operator office there will be bin locations reserved for Auction partners. The item deregistration module will allow for user to assign an item to an auction partner and new bin location for ‘pick-up.’ Information for auction partners is maintained so that upon assigning an item to the auction partner, processing documents for sending the item to the auction partner are automatically prepared. The IMS 100 is optionally configured to automatically review the registered items, remove them from inventory and assign them to a bin reserved for items to be auctioned, and assign them to an auction partner. The documents are then automatically produced.

### Lost and Found Module Operation—Inquiry Processing.

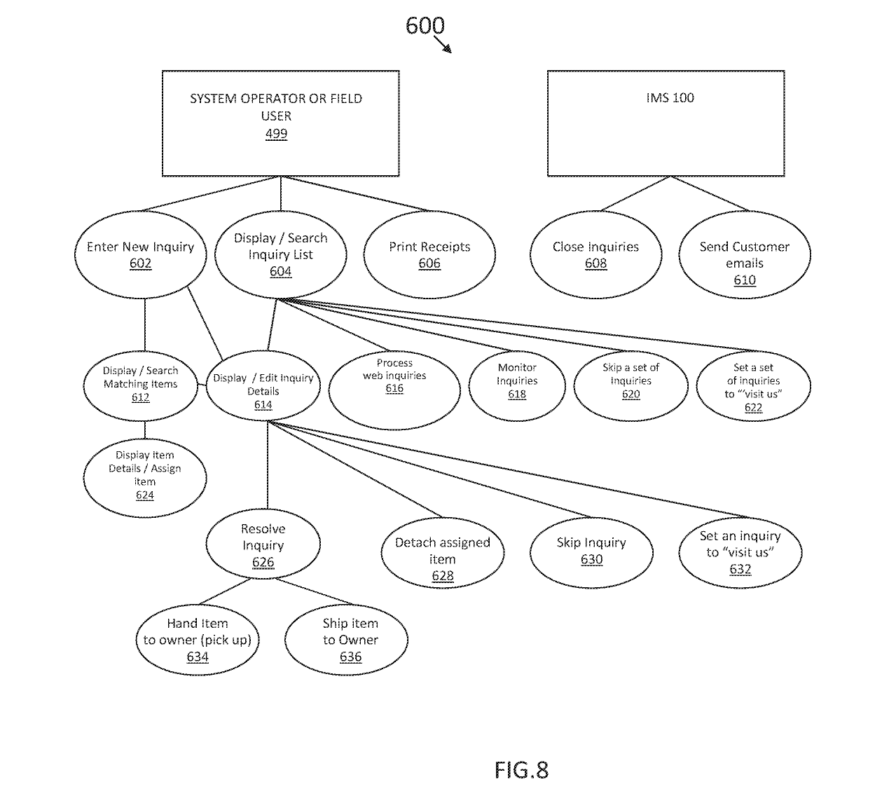

Return of found and registered items is accomplished by an inquiry customer either making an inquiry with the Operator 499 via the customer coming to an office thereof, or calling the Operator 499, or a contractor or sub-contractor thereof, and providing inquiry information, or the customer accessing the web server 120 of the IMS 100 using a customer platform 112 and a web browser to enter an inquiry. Referring to FIG. 8, an inquiry processing configuration 600 shows a site map type depiction of dialogue operations of the IMS 100 as it pertains to processing an inquiry. The inquiry processing module 225, of FIG. 3, handles entry of inquiry data. Either the system operator or a field user 499, accesses the IMS 100 via the web server 120 to process inquiries from persons whom have lost an item. A new inquiry entry dialogue operation 602 allows the user to initiate process of a new inquiry. TABLE 6 below presents sub-operations for entry of an inquiry.

TABLE 6
INQUIRY ENTRY AND SEARCH PROCEDURE - USER ENTRY

| NO. | SUB-OPERATION | EXECUTOR | DESCRIPTION |
|---|---|---|---|
| 6-1 | Enter new inquiry | Operator | Event: A customer has lost an item and |
| | initiation | operations | wants to start an inquiry by visiting the |
| | | | Operator L&F counter, making a phone |
| | | | call or sending an email or a Fax. |
| 6-2 | Enter fixed | Operator | The user selects and enters a number of |
| | attributes | operations | fixed attributes used for all kinds of |
| | | | items including designations from |
| | | | Categories 1, 2 and 3. |
| 6-3 | Enter multipurpose | Operator | Based on a set of categories, a set of |
| | attributes | operations | individual attributes is entered. |
| 6-4 | Enter Customer data | Operator | Enter customer address and |
| | | operations | identification data |
| 6-5 | Send a confirmation | IMS 100 | On entering a new inquiry a |
| | email | | confirmation email is sent to the |
| | | | customer. |

An enter new inquiry initiation 6-1 event occurs when the Operator is contacted by a customer with an inquiry regarding a lost item. The user begins the enter new inquiry sub-operation by accessing the associated dialogue on the web site and executing the sub-operation 6-2 entering fixed attributes of the lost item as listed in TABLE A6 below. In addition to fixed attributes being entered into the IMS 100, the inquiry processing module 225 optionally generates fields automatically as indicated in TABLE 6A. For the “Found where” and “Found where details” the fields are completed based upon information provided by the inquiry customer as to where the item may have been lost. The “Found” data fields are used to verify customer ownership of a found item and are optionally not displayed via the website to customers accessing the IMS 100 in quest of their lost item when displaying found item details. This restriction in displaying information, is not critical as other item indicia may be used to confirm ownership. However, the restriction is an advantageous embodiment of inquiry processing.

TABLE 6A
INQUIRY ATTRIBUTES - USER ENTRY

| ATTRIBUTE | DESCRIPTION | INPUT |
|---|---|---|
| Inquiry ID | Generated by the IMS 100 8 Digits | IMS 100- |
| | | generated/ |
| | | Display only |
| Inquiry State | Generated by IMS 100. Set to “open” | IMS 100- |
| | on entering the inquiry. | generated/ |
| | | Display only |
| Incoming | Selection of the channel the inquiry is | Select one of the |
| channel | communicated to Operator. “Online” | following: Counter; |
| | is only used by the IMS 100 when a | email; phone; or |
| | customer uses the web-application. | Fax. |
| Mode of | Generated by IMS 100. Left empty | Drop down |
| customer | field on entering an inquiry. Values: | |
| delivery | 1. Picked up; 2. Shipped. Contains the | |
| | information if the item is picked up or | |
| | shipped when resolving the inquiry | |
| | and returning the item to the customer. | |
| User | Generated by IMS 100. Name of the | IMS 100- |
| | user logged into the IMS 100 | generated/ |
| | | Display only |
| Matched item ID | Generated by the IMS 100. Set to empty | IMS 100- |
| | field on entering an inquiry. Clicking on | generated/ |
| | the ID opens the item details. | Display only |
| Date/Time of | Generated by the IMS 100. The | IMS 100- |
| creation | date/time the inquiry is entered into | generated/ |
| | the IMS 100 by Operator manually or | Display only |
| | by the customer online. This attribute | |
| | must not be changed after entering an | |
| | inquiry. | |
| Date/Time of | Generated by the IMS 100. The | IMS 100- |
| opening the | date/time of opening the inquiry. Set | generated/ |
| inquiry | to Date/Time of creation on entering | Display only |
| | a new inquiry | |
| Date/Time | Generated by the IMS 100. The | IMS 100- |
| resolved | date/time the inquiry is resolved. Set | generated/ |
| | to empty on entering a new inquiry. | Display only |
| Date/Time | Generated by the IMS 100. The | IMS 100- |
| latest | date/time the monitored the last time. | generated/ |
| monitoring | Set to empty on entering a new | Display only |
| | inquiry. | |
| User latest | User name of the logged in user who | IMS 100- |
| change | made the latest change. Equals User | generated/ |
| | on creating a new inquiry. | Display only |
| Date/Time | Generated by the IMS 100. The | IMS 100- |
| latest | date/time of the last change made to the | generated/ |
| change | inquiry. Equals Date/Time of creation | Display only |
| | on entering a new inquiry. | |
| Date/Time lost | The date/time the item has been lost. | Calendar control |
| | This information is given by the | and Input of the |
| | customer. | time. Default for |
| | | time is “00:00” |
| Category 1 | Main Category of lost | Drop down with |
| | item. (identical with item's | autocomplete |
| | categories) | |
| Category 2 | Sub Category (only Cat 2s that | Drop down with |
| | are assigned to Cat 1 are | autocomplete. |
| | possible). (identical with item's | |
| | categories) | |
| Category 3 | Sub Category (only Cat 3s that | Drop down with |
| | are assigned to Cat 2 are | autocomplete. |
| | possible). (identical with item's | |
| | categories) | |
| Color | Selection of administered colors | Drop down with |
| | (may be “Other”). (identical with | autocomplete. |
| | item's colors) | |
| Found where | Selection of administered locations | Drop down with |
| | (may be “Other”). Examples:. Terminal | autocomplete. |
| | 1. Airline X. - Security area. (identical | |
| | with item's Found where) | |
| Found where | Location details. Mandatory if location is | Free text |
| details | not provided in “Found where” (thus | |
| | “Other”). Examples:. Flight Number - | |
| | Seat XXX | |
| Note | Space for additional information on | Free text |
| | the item or customer | |
| Staff note | Space for internal staff information. | Free text |
| | For example information about | |
| | ongoing communication, To Dos etc. | |

In sub-operation 6-3 the user optionally enters multipurpose attributes which comprise a set of 5 additional free text attributes. The meaning of these attributes (and thus the field label within the dialogue) optionally vary dependent on the combination of Category 1-3. APPENDIX A provided at the end of this description, provides an exemplary listing of designations for Categories 1 through 3, respectively corresponding to the bold designations of the first three indentation levels of the listing, and italicized subjects (questions or listing) for entry as a multipurpose attribute. For example, if a Kindle e-reader is the subject of the inquiry, Category 1 would be “H. Electronics,” Category 2 would be “4. E-Reader,” and Category 3 would be “c) Kindle.” When Category 1 is selected to be “H. Electronics,” the inquiry processing module 220 will call up questions associated with this Category 1 designation which are “(1) What brand?”, and “(2) Is the device in a casing/folder?” Responses to these questions are accepted as multipurpose attributes. Since “H. Electronics” is selected, only sub categories thereof are selectable, i.e., cables, electronics, E-Reader, game console, media and music player, and USB flash drive are available Category 2 selections. In this example, multipurpose category prompts are displayed upon selection of Category 1 to elicit entry of information considered common to all items falling under the Category 1 “H. Electronics” designation. Similarly, such multipurpose category prompts are optionally made when either designation for Categories 2 and 3 are selected. For example, Category 1=“D. Camera,” Category 2=“Photo camera” will generate a prompt suggesting entry of a multipurpose attribute comprising a type of photographs existing on the camera, e.g., flowers, beach, etc. Accordingly, the multipurpose attributes are category dependent and vary in a manner that adapts the multipurpose attributes to various items defined by the categories. Thus the multipurpose attributes are displayed after the input of the three fixed categories and refreshed whenever the categories are changed. They are used for both back office and customer web frontend (customer website) with identical meaning. Special marks (such as stickers, scratches etc.) may be entered here. The system does not check the content that is entered but this content is used to help verify ownership of an item. Another embodiment of inquiry registration may make multipurpose attributes independent of categories wherein the multipurpose attributes are configured in a generic fashion.

Categories 1-3 are described as “fixed” because they are set in the L&F categories module 255 of FIG. 3 by the Operator and are not varied by the field users. However, the designations for these categories are not “fixed” in the respect that they may be changed and updated by the system operator. This is done via the LFADM 250 and the L&F categories module 255 which present the Operator with the option of adding or changing category designations and category dependent prompts, examples of which are illustrated in the APPENDIX A (provided at the end of this description).

In sub-operation 6-4 customer data is entered and comprises the information presented below in TABLE 6B. Following entry of the customer data, the inquiry processing module 240 optionally automatically generates and sends a confirmation email to the inquiry customer.

TABLE 6B
CUSTOMER INFORMATION

| ATTRIBUTE | DESCRIPTION | INPUT |
|---|---|---|
| Salutation | | |
| Customer name | | Free text |
| Customer first name | | Free text |
| Company | | Free text |
| Address appendix | Additional Address line The | Free Text |
| | Address is not always used in | |
| | case customers pick up their | |
| | item at the bag port counter. | |
| | Thus optional. | |
| Street/Number | | Free text |
| ZIP Code | | Free text |
| City | | Free text |
| Country | | Drop down with |
| | | autocomplete. |
| State | Used for USA - addresses | Drop down with |
| | | autocomplete. |
| email | The customer's email- | Free text, email- |
| | Address | syntax is checked |
| | | by the system |
| Phone | Customer's Phone Number | Free text |
| Fax | Customer's Fax Number | Free text |

Following completion of entry of the new inquiry via the enter new inquiry dialogue operation 602, the inquiry processing module 225 of FIG. 3 optionally will automatically run a matching search on the inquiry upon completion of the entry of the inquiry. Alternatively, the search may be manually initiated by the user from the enter new inquiry dialogue operation 602. Whether automated or user initiated, processing will proceed to the display/search matching dialogue operation 612 of FIG. 8 by triggering operation of the item matching module 220 of FIG. 3. The result of the search will produce possible matches, also called pre-selected items because selection of one of the items initiates the displaying of the item details and an option to select the item to be assigned or pre-assigned to the selected inquiry in a display item details/assign item dialogue operation 624

Identification of a lost item, i.e., assigning a registered found item to an inquiry, is not as straight forward as finding exact correspondence of the fixed and multipurpose attributes because of inaccuracy or a subjective nature of information used. For example, an inquiry customer may not accurately recall a manufacturer of an item but may guess at it. Furthermore, information such as color is subjective as two persons looking at the same item may describe it using different color names, especially in view of the common disability of color blindness. Thus, in an embodiment of the IMS 100 a weighted matching algorithm which scores possible matches is optionally employed.

An example of an optional weighting criteria assigns points for matching attributes. For example, and not limitation, the following weight might be used: Color=5; Category 3=50; Found location=20; Security Bag ID=100; Item Attributes=50× Weight (default weight is 1). The attributes to which weights are assigned, and the “Weight” values, are optionally varied by the Operator and may be varied based on experience of matching accuracy.

In the above weight example an optional implementation is effected wherein a match scoring is only be assigned if Categories 1 and 2 are a match between a registered found item and an entered inquiry. This is a hybrid search criteria since the weighting criteria only applies to fields other than categories 1 and 2 which require a match and are not scored in the weighting. Alternatively, a fully weighted scoring may be effected regardless of whether there is a match of Categories 1 and 2 with weights being assigned to categories 1 or 2 of the inquiry matching those of a registered item.

Examples of category designations for a Category 1 designation of “Clothing” are shown in TABLE 7 below wherein categories 1, 2, and 3, correspond to the indentation of the outline. In the example shown, Category 1 is “Clothing”, Category 2 designations are “Clothing”, “Headgear”, “Jackets”, etc., and Category 3 designations are shown as the next lower outline level. A non-limiting and non-exhaustive example of a set of Category 1 designations is: Art, Books/Magazines, Camera, Cigarettes/Tobacco/Alcohol, Clothing, Computer Equipment, Electronics, Glasses, Jewelry, Keys, Mobile Phones, Security Documents, Travel Effects, Various, and Watch. A more extensive example of categories is presented in APPENDIX A (provided at the end of this description) wherein the first three levels (indentation levels) of the listing correspond respectively to Categories 1, 2 and 3.

TABLE 7
EXAMPLE CATEGORY
Category 1 - Clothing

| | |
|---|---|
| 1. | lothing |

| | |
|---|---|
| A. | Clothing |

| | |
|---|---|
| 1. | Belt |
| 2. | Blouse |
| 3. | Breeches |
| 4. | Cardigan |
| 5. | Clothing Other |
| 6. | Costume |
| 7. | Dress |
| 8. | Gloves |
| 9. | Scarf/Shawl |
| 10. | Shoes/Boots |
| 11. | Tie |
| 12. | Uniform |

| | |
|---|---|
| B. | Headgear |

| | |
|---|---|
| 1. | Cap |
| 2. | Ear |
| 3. | Hat |
| 4. | Headgear Other |
| 5. | Peaked Cap |
| 6. | Sunhat |

| | |
|---|---|
| C. | Jackets |

| | |
|---|---|
| 1. | Coat |
| 2. | Jackets |
| 3. | Jackets Other |

| | |
|---|---|
| D. | Shirts |

| | |
|---|---|
| 1. | Shirt |
| 2. | Sweater |
| 3. | T-shirt |

| | |
|---|---|
| E. | Trousers |

| | |
|---|---|
| 1. | Jeans |
| 2. | Leather Breeches |
| 3. | Shorts |
| 4. | Skirt |
| 5. | Sweatpants |
| 6. | Trousers Other |

The item matching module 220 compares the entered inquiry against the registered found items and generates a score based on the weighting criteria and then, in dialogue operation 612 of FIG. 8, displays a list of possibly matching registered found items, also called pre-selected items, with the found items having the highest score at the top of the list with the remaining “matching” found items being displayed in accordance with descending score values. The item matching module 220 optionally uses a threshold point score to limit the listing of pre-selected items wherein the point score for an item must meet or exceed the threshold to be included in the listing. The user is able to sort the listing by columns actuating column headings of attributes. The user may select any of the listed “matching” items from the list to proceed to dialogue operation 624 wherein details of the selected item are displayed.

As an alternative to the weighted matching, the item matching module 220 optionally uses the following matching criteria:
1. Matching Category 1
2. Matching Category 2
3. Matching Category 3
4. Date/Time lost of inquiry<=Date found of item (without taking time into consideration)
5. If Date/Time last monitored of inquiry is not empty: Date/Time last monitored of inquiry<=Date registered of item. Explanation: If the inquiry has already been tried to match by monitoring or when entering the new inquiry, items that had been received by then have already been checked for matching.
6. Item state=“received” OR Item state=“registered” OR item state=“c-matched”, i.e., customer matched via the L&F customer web frontend module 205 discussed below.

The initial sort order is date found of item, descending (the latest item at the top). By selecting an item the item details are displayed.

In dialogue operation 624, the user can either assign a selected item to the inquiry if the user is confident that the selected item corresponds to the inquiry, or the user may pre-assign the item to the inquiry if the item appears to match the inquiry but further verification is deemed required. In dialogue operation 624 a displayed dialogue includes buttons for both matching, i.e., assigning, and pre-assigning. If the user assigns the selected item to the inquiry, the item matching module 220 automatically sends a match notification email to the inquiry customer.

When an item is assigned to an inquiry, the user is very confident that the customer is the owner of the item and he wants the customer to be informed by the email notification. The following changes are automatically made to the inquiry attributes by the item matching module 220:
1. Inquiry state is set to “Matched”
2. Matched item ID is set to the present item ID
3. Date/Time latest change is set
4. User latest change is set; and
5. Date latest monitoring is set.
   The following changes are made to the item attributes:
1. Item state is set to “Matched”
2. Matched inquiry ID is set to the present inquiry ID
3. Date/Time latest change is set; and
4. Date/Time user latest change is set
   The changes made to the inquiry attributes and the item attributes are logged by the item logging module 230 shown in FIG. 3. Changes made to the item are logged as documented

If the user is not sure that the selected item matches the inquiry and belongs to the inquiry customer, he pre-assigns the item to the inquiry in order to establish proof of the ownership and assign it later. The following changes are made by the item matching module 220 to the inquiry attributes:
1. Inquiry state us set to “Pre-Matched”
2. Matched item ID is set to the present item ID
3. Date/Time latest change is set
4. User latest change is set
   The following changes are made to the item attributes:
1. Item state is set to “Pre-Matched”
2. Matched inquiry ID is set to the present inquiry ID
3. Date/Time latest change is set
4. Date/Time user latest change is set
   Changes made to the item are logged by the item logging module 230. No email is sent to the inquiry customer.

Whenever an attempt to find a matching item is not successful, the user can decide to click “Monitored” which is presented in dialogues in order to update the Date latest monitoring attribute of the inquiry. The following changes are made to attributes of the inquiry by either the item matching module 220 or the item monitoring module 240:

1. Date/Time latest monitoring is set

2. Date/Time latest change is set

3. User latest change is set

The purpose of this update is, that in future monitoring optionally only items received later (or on the same day) than the Date latest monitoring are pre-selected as possible matches by the system when displaying possibly matching items. This expedites the matching of inquiries to registered found items. Alternatively, this limitation on pre-selecting by the item matching module 220 may be over-ridden if it is felt that prior pre-selections should be re-evaluated.

Display/search inquiry list dialogue operation 604 may be selected by a user and the sub-operations detailed in TABLE 8 below may be effected by the user. Inquiries are displayed within a list dialogue. The list displays a row for each inquiry and the row optionally contains the following attributes:

Inquiry ID

1. Inquiry State

2. Customer Name

3. Date/Time of creation

4. Date/Time latest monitoring

5. Category 1

6. Category 2

7. Category 3

8. Found where

The initial sort order is Inquiry Id descending (newest inquiry at the top)

TABLE 8
INQUIRY DISPLAY AND SEARCH PROCEDURES

| NO. | SUB-OPERATION | EXECUTOR | DESCRIPTION |
|---|---|---|---|
| 8-1 | Display/Search | Operator | Inquiries are displayed within a list |
| | inquiry list | operations | dialogue. |
| 8-2 | Sort the list | Operator | The list can be sorted (ascending or |
| | | operations | descending) by the displayed fields |
| | | | (one field at a time). |
| 8-3 | Filter the list | Operator | The list can be filtered by the user. |
| | | operations | |
| 8-4 | Free text search | Operator | A free text search on inquiries is |
| | | operations | provided. |

The list can be filtered by the user using the following means:

1. Free text search (input of a string)

2. Selecting Creation Date from/to (calendar-widgets) (tenant's time zone)

3. Selecting Date Lost from/to (calendar-widgets) (tenant's time zone)

4. Selecting Date last monitored from/to (calendar-widgets) (tenant's time zone)

5. Category 1 (drop-down)

6. Category 2 (drop-down)

7. Category 3 (drop-down)

8. Found where (drop-down)

9. Inquiry state (drop down)

The filter works by default using the Boolean “AND” operator. Optionally, the user may override the and operator and use a Boolean “OR” operator. An exception to the default “AND” operator occurs whenever the free text search is submitted, all filters are reset to “all”. However, a list filtered by the free text search can then be refined by using the drop down-filters. The free text search optionally searches some or all of the following fields of the item details:

1. Inquiry ID

2. Category 1

3. Category 2

4. Category 3

5. Multipurpose attribute 1

6. Multipurpose attribute 2

7. Multipurpose attribute 3

8. Multipurpose attribute 4

9. Multipurpose attribute 5

10. Color

11. Found where

12. Found where detail

13. Customer Name

14. Customer first name

15. Company

16. Street

17. Country

18. Note

19. Staff note

Additionally, the user may select any of the inquiries for display of details or editing in which case processing proceeds to a display/edit inquiry details dialogue operation 614. The display/search matching items dialogue operation 612 also allows the user to proceed to the display/edit inquiry details dialogue operation 614. The details of the selected inquiry are then displayed and editing by the user is accepted. This may be done when a search proves ineffective and it is determined that details of the inquiry must be changed. Furthermore, the display and edit inquiry details dialogue operation 614 allows the user to proceed to a resolve inquiry dialogue operation 626 which is used when an inquiry has been assigned an item. The resolve inquiry dialogue operation 626 presents options to the user comprising a hand item to owner (pick up) dialogue operation 634, and/or a ship item to owner dialogue operation 636.

When an inquiry is matched, i.e. assigned, and the item is handed out or shipped, the inquiry is resolved. The inquiry is found and selected in the display/search inquiry list dialogue operation 604 for editing in the display/edit inquiry details dialogue operation 614. Dependent on the mode of delivering the item to the customer, the user sets the mode of customer delivery to “picked up” or “shipped”. He can reset it to “empty” in case of error. After having set the mode, a button “Resolve” is activated and processing proceeds to the resolve inquiry dialogue operation 626. The following changes are made to inquiry attributes by either the item matching module 220 or the item deregistration module 235 on resolving:

1. Inquiry state is set to “resolved”

2. Mode of customer delivery is set to selected value

3. Date/Time resolved is set

4. Date/Time last change is set

5. User last change is set

The following changes are made to the item attributes by either the item matching module 220 or the item deregistration module 235 on resolving:

1. Item state is set to “resolved”

2. Date/Time last change is set

3. User last change is set

4. Storage area is set to empty

5. Bin location is set to empty

Additionally, the bin location is released in order to be occupied by new items coming in.

In case an item has been assigned to an inquiry and the Operator finds out by communicating with the customer that the item is not the item he has lost, the item is detached using a detach assigned item dialogue operation 628. Detaching an item may also be desired in case an item has been assigned to an inquiry by a customer using the L&F customer web application, i.e., the L&F customer web frontend module 205 and the Operator proves that the item is not the item the customer has lost. When the item is detached the following changes are made to the inquiry attributes:

1. Inquiry state is reset to “open”

2. Matched item ID is set to empty

3. Date/Time last change is set

4. User last change is set

Inquiry's Date/time opened is not altered. The following changes are made to the item attributes:

1. Item state is reset to “registered”

2. Matched inquiry ID is set to empty

3. Date/Time last change is set

4. User last change is set

A skip inquiry dialogue operation 630 may be accessed by selecting an inquiry from the inquiry list displayed in the display/edit inquiry details dialogue operation 614 and further selecting a button for the skip dialogue operation 630. Depending on the input data of the inquiry the Operator can decide and skip an inquiry. The skipped inquiry is no longer monitored by the Operator

Additionally accessible via the display/edit inquiry details dialogue operation 614, a set inquiry to “visit us” dialogue operation 632 is optionally provided. If the user decides that the item the customer has lost, is not likely to be identified by the Operator, the user sets the inquiry to “visit us.” The customer is informed by an email automatically generated by the inquiry processing module 225 that the only way to retrieve his item is to visit the Operator in order to identify the item.

The item monitoring module 240 of FIG. 3 effects monitoring of entered inquiries. The monitoring of an inquiry entails periodically conducting a search of registered found items based on the attributes of the inquiry. as done via the item matching module 220 as controlled through the display/search matching items dialogue operation 612. TABLE 9 below lists the sub-operations performed for Operator initiated monitoring. In sub-operation 9-1 the user (Operator or client) initiates monitoring an inquiry by selecting an inquiry for monitoring in the display/search inquiry list dialogue operation 604. The details of the select inquiry are displayed in the display/edit details dialogue operation 614 from which the display/search matching items dialogue operation 612 is initiated. This is then followed by the display item details/assign item to inquiry dialogue operation 624. Upon assigning the item to the inquiry, the IMS 100 effects an assign item to inquiry procedure detailed in TABLE 10 below

TABLE 9
INQUIRY MONITORING PROCEDURES

| NO. | SUB-OPERATION | EXECUTOR | DESCRIPTION |
|---|---|---|---|
| 9-1 | Monitoring | Operator | Inquiries are monitored frequently in |
| | inquiries | operations/IMS | order to find matches of items |
| | | 100 | recently received. |
| 9-2 | Send an email on | IMS 100 | When an inquiry has been monitored |
| | monitoring the first | | the first time, the customer is |
| | time | | informed by an email that the item is |
| | | | not received by now and that his |
| | | | inquiry is being monitored. |
| 9-3 | Send a notify email | IMS 100 | On follow up monitoring, the |
| | on follow up | | customer is informed by an email that |
| | monitoring | | the item is not received yet and that |
| | | | his inquiry is still being monitored. |

TABLE 10
ASSIGN ITEM TO INQUIRY PROCEDURE

| NO. | SUB-OPERATION | EXECUTOR | DESCRIPTION |
|---|---|---|---|
| 10-1 | Assign item to the | Operator | On the item details dialogue the user |
| | inquiry | operations/ | assigns the item to inquiry, if he is |
| | | IMS 100 | confident, that the item is property of |
| | | | the customer. |
| 10-2 | Send email to | IMS 100 | On the assignment of a matching |
| | customer on | | inquiry the customer receives an email |
| | assigning an item | | sent automatically by the system. |
| 10-3 | Pre-Assign item to | Operator | On the item details dialogue the user |
| | the inquiry | operations/ | pre-assigns the item to inquiry, if the |
| | | IMS 100 | item is probably the property of the |
| | | | customer. |

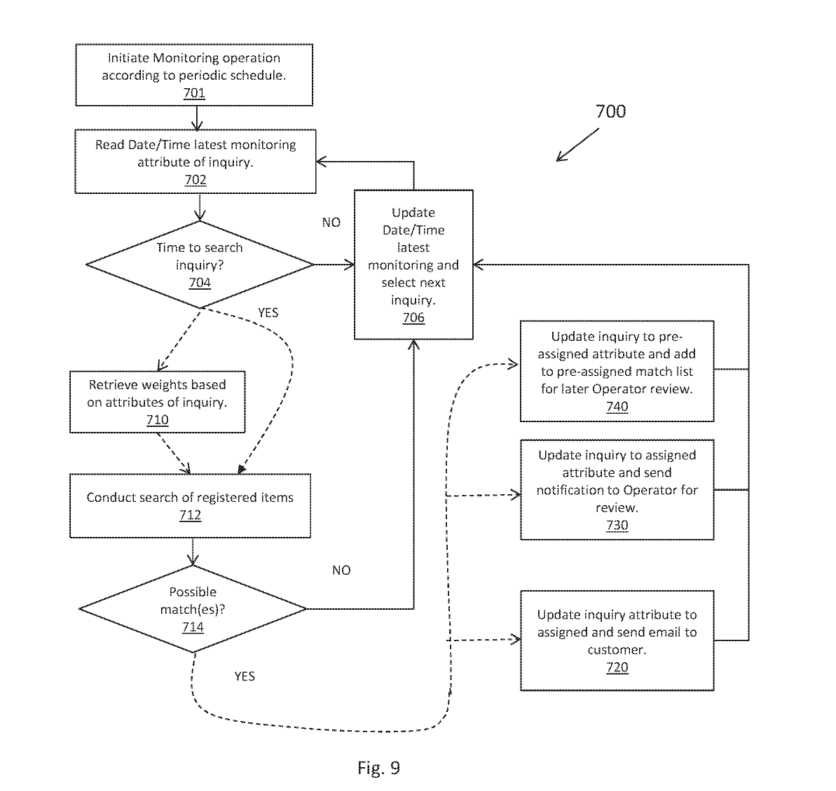

Referring to FIG. 9, an automated monitoring process 700 is optionally automatically conducted by the monitoring module 220 of the IMS 100. The monitoring process 700 is initiated by the item monitoring module 240 in operation 701 according a schedule which is optionally periodic, such as for example and not limitation, every night when system processing demands are reduced. In operation 702 an inquiry from a list retrieval of inquires which are not closed or assigned is selected by the IMS 100 and the Date/Time of the last monitoring is read. In decision operation 704 it is determined whether a predefined period has elapsed since the last time a search using the inquiry was conducted. If the predefined period has elapsed or no data is stored, indicating the inquiry has not been used to search registered found items, the decision is affirmative and the process proceeds through either of two optional flows corresponding to alternative embodiments searching used in the monitoring process 700. If the search is to use a fixed set of weights flow proceeds to operation 712 wherein a search based on the selected inquiry is conducted using the fix set of weights corresponding to the inquiry attributes. If the search is to use a variable set of weights, flow proceeds to operation 710 wherein a set of variable weights is retrieved based on attributes of the inquiry, i.e., the weights are dependent upon the type of item involved. The type of item may be defined in accordance with categories 1, 2, or 3, discussed below

A variable set of weights is optionally used to tailor weights used in a weighted search to various types of inquiries. For example and not limitation, it may be found that certain weighting parameters provide a best result for an inquiry having one or a combination of Category 1, 2 and/or 3 attributes while another set of weighting parameters is best for a second combination of Category 1, 2 and/or 3 attributes. It need not be a combination of attributes, but may also be based solely on one attribute, such as from Category 1 of the inquiry to be used for searching, or other groupings of item types which are correlated to categories but not defined by categories. With reference to APPENDIX A (provided at the end of this description), for example, a certain set of weights may prove effective in searching certain electronic items yet the Category 1 includes several classes of items that are electronic in nature, such as an-reader and a tablet computer which are assigned two different Category 1 designations, respectively “Electronics” and “Computer Equipment.” Thus, this certain weight set is considered correlated to these Category 1 designations, as oppose to a weight set which is defined by categories, such a weight set which is used for Category 1=“Computer Equipment” and Category 2=“Tablet.”

A threshold score value is used for determining if there is a possible match. In an embodiment the threshold value is fixed. In another embodiment, a threshold value is attribute dependent. Still further, multiple thresholds may be used which are either fixed or variable based on attributes, wherein the multiple thresholds are respectfully for different confidence levels in a possible match. A high threshold is optionally used to automatically assign an item to the inquiry. A lower threshold may be used to pre-assign an item to the inquiry so that the Operator may later review the pre-assignment to determine if it is correct and change the status to assigned. A still lower threshold value may be used as an eliminator of items to be considered as possible matches. Thus, all items having a score equal to or above the threshold value will be stored or displayed in a list of possible matches for an inquiry. Following retrieval of the weights flow proceeds to operation 712 wherein the search is executed.

In decision operation 714 it is determined whether scores developed by the weighted comparison of attributes are greater than a given one of the thresholds so that it is considered possible that the match is correct. If a threshold is not crossed, flow proceeds to operation 706 which operates to update the present inquiry with the date of the present search and to select a next inquiry. If the decision is in the affirmative, flow optionally proceeds along a flow of one of three alternative embodiments of the monitoring process 700. In operation 720, the item monitoring module 220 will update the inquiry attribute to “assigned” and send an email notifying the customer This is done if there is a high confidence level which would equate to a high threshold being used. Alternatively, operation 730 may be executed which also sets the inquiry to “assigned” but places the inquiry on a notification list to alert the Operator to conduct a further review before notifying the customer. Yet a third embodiment operation 740 update the inquiry to pre-assigned and places the inquiry on a pre-assigned match list for later review by the Operator. Thus, as new found items are registered, the IMS 100 is configured to optionally automatically check inquiries to see if a match is found among the registered items.

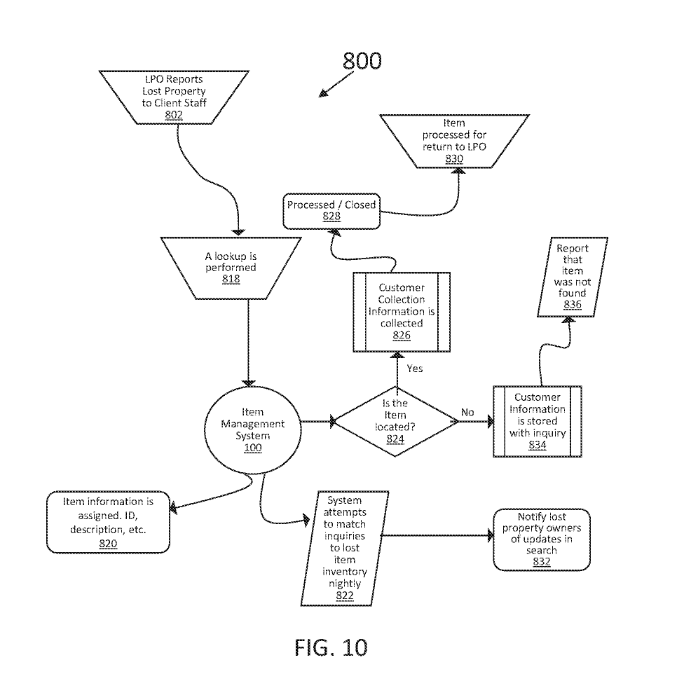

Referring to FIG. 10, there is shown a partial overview of an embodiment of a lost and found method 800 of operation of the present disclosure. As discussed above, the IMS 100 periodically conducts searches based on inquiries and prepares a listing of inquiries having possible matches. In FIG. 9 the IMS is shown as configured to attempt to match items to inquiries nightly in system operation 822. In decision operation 824 it is determined whether a registered found item matches the inquiry. This decision in the case of monitoring may be made by the Operator or the IMS 100 using the automated monitoring process 700 of FIG. 9. Inquiries are optionally monitored frequently in order to find matches of found items recently received. The IMS 100 notifies customers via email in operation 832 when a monitoring is executed and updates the customer. When an inquiry has been monitored the first time (as determined by an empty last monitored data attribute of the inquiry) and a match is not found, the customer is informed by an email that the item is not received by now and that his inquiry is being monitored. On a follow up monitoring without a match being achieved, the customer is informed by an email that the item is not received yet and that his inquiry is still being monitored.

In manual operation 802 a lost property owner (customer to be) reports a lost item to the Operator or client staff. The Operator/client staff enters an inquiry in operation 818 which is effected via dialogue operations 602 and 612 of FIG. 8 performing a search via the item matching module 220 of FIG. 3. The entry of the inquiry includes the assignment of and item ID to the inquiry and storing item information in operation 820. The IMS 100 returns search results and a decision operation 824 is made by the Operator/client staff as to whether a matching item is found. If the decision is negative, flow proceeds to operation 834 wherein customer information is stored with the inquiry and the IMS 100 reports via email that an item was not found, of if the customer is present a report is printed and given to the customer. If the decision is in the affirmative, customer collection (payment) information is collected in operation 826 followed by the inquiry being processed and closed in operation 828. This is procedure is detailed in TABLE 11 below.

TABLE 11
INQUIRY RESOLUTION PROCEDURE

| NO. | OPERATION | EXECUTOR | DESCRIPTION |
|---|---|---|---|
| 11-1 | Resolve an | Operator | When the inquiry is matched to an |
| | inquiry | operations. | item and the owner is verified, the |
| | | | inquiry is being resolved. The item is |
| | | | handed out or shipped to the |
| | | | customer . . . The verification of the |
| | | | owner is done by means of email or |
| | | | phone and not a subject to be |
| | | | supported by the IMS 100 . . . |
| 11-2 | Send a notify | IMS 100. | The customer is informed by an email |
| | email on | | that the L&F office has found his |
| | Resolving | | item . . . |
| 11-3 | Hand out Item to | Operator | When the inquiry is resolved and the |
| | Owner | operations. | customer visits the Operator counter, |
| | | | his lost item is handed out to him . . . |
| 11-4 | Print owner's pick | Operator | On handing out the item, an owner's |
| | up receipt. | operations. | receipt is printed via a print receipt |
| | | | operation/dialogue 606 of FIG. 8. The |
| | | | customer signs it and returns it to |
| | | | Operator . . . |
| 11-5 | Ship item to | Operator | When the inquiry is resolved the item |
| | Owner | operations. | is shipped to the customer in the ship |
| | | | item operation/dialogue 636 of FIG. 8, |
| | | | if he wishes the item to be shipped . . . |
| 11-6 | Send a notify | IMS 100. | The customer is informed by an email |
| | email on resolving | | that the inquiry has been resolved and |
| | | | the item is going to be shipped . . . The |
| | | | customer only receives an email in |
| | | | case the item is not handed out but |
| | | | shipped to him . . . |

Further inquiry processing operations include a skip a set of inquiries dialogue operation 620 wherein the Operator selects a set of inquiries in the display/search inquiry dialogue operation 604 and then selects a skip button when the Operator decides to skip inquiries. A skipped inquiry is no longer monitored by the IMS 100. A set inquiry set to “visit us” dialogue operation 622 is likewise accessed by selecting a “visit us” option when a set of inquiries is selected in the display/search inquiry list dialogue/operation 604. The Operator optionally decides to set a set of inquiries to “visit us.” These inquiries are no longer monitored by the IMS 100 and the customer is sent an email requesting that a visit or contact be made because assigning an item to the inquiry requires personal interaction. Additionally, the IMS 100 automatically checks inquiries to see if they are 90 days old or older and closes the inquiries in dialogue operation 608 and automatically sends an email to the customer informing him of the closed inquiry.

The inquiry processing configuration 600 further includes a process web inquiries dialogue/operation 616 accessible via the display/search inquiry list dialogue/operation 604. New inquiries are coming in from customers submitting inquiries using the web customer frontend module 205. These inquiries are sorted out in the inquiry listing and are checked by the Operator. After being checked and opened they are ready for matching and further monitoring.

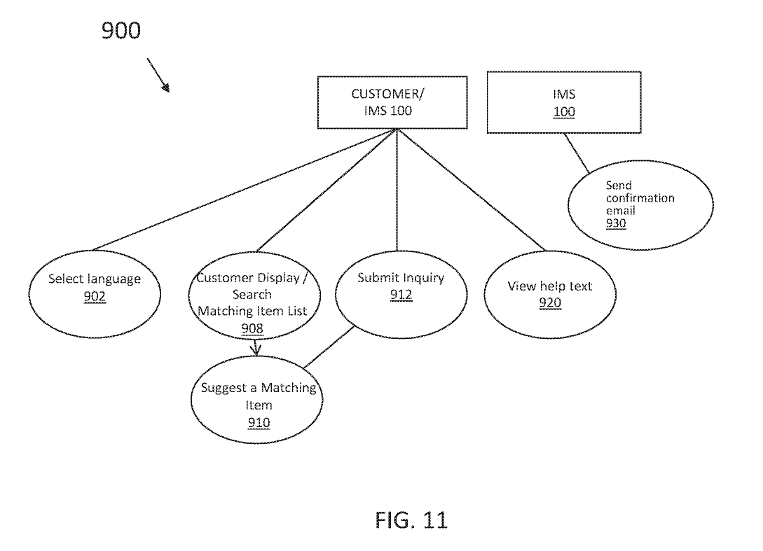

Referring to FIG. 11, a customer web frontend configuration 900 details a site map which is accessible to customers via the internet/intranet 102, hosted on the web server(s) 120 of FIG. 1, and implemented by the lost and found customer web frontend module 205 of FIG. 3. A select language c902 presents the customer with a list of languages from which the customer selects the language he prefers. A customer display/search matching items dialogue/operation 908 presents the customer with an option to search for his item before he submits an inquiry. The customer display/search items dialogue 908 is restricted regarding the attributes displayed for security purposes because the customer must not view details which are important to verify him as the legitimate owner. Therefore Categories 1, 2 and 3, are displayed but multipurpose attributes are optionally not displayed. A list of items is displayed. Only items containing the state “registered” are selected for display. The following attributes are displayed:

1. Item ID

2. Category 1

3. Category 2

4. Category 3

5. Color

6. Date found (without time)

In an embodiment, attributes like “Found where” one would expect here are not displayed for the reason that this information is used when verifying the customer as the legitimate owner. Likewise, multipurpose attributes are not displayed. Alternatively, such restrictions may be removed by the system operator. The list can be sorted (ascending or descending) by the displayed fields (one field at a time). The initial sort order is Item ID descending (newest item at the top). The list can be filtered by the user using the following means:

1. Free text search (input of a string)

2. Selecting Date found

3. Category 1 (drop-down)

4. Category 2 (drop-down)

5. Category 3 (drop-down)

Filters work using the “AND”—conjunction with the exception that whenever the free text search is submitted, all filters are reset to “all”. However, a list filtered by the free text search can then be refined by using drop down-filters. The free text search, sort and filter controls are optionally implemented as a “header” of the item list dialogue. The customer is thus optionally able to see his adjustments while working with the list view. The free text search searches any of the following attributes of the item: Category 1, Category 2, and or Category 3. The suggest a matching item dialogue/operation 910 optionally presents each item row with a checkbox control. The column is headed “This might be my item”. The customer checks the item and clicks a button “Start inquiry”. The inquiry dialogue is displayed and contains a display of the following item attributes:

1. Item ID

2. Category 1

3. Category 2

4. Category 3

5. Color

6. Date found (without time)

A submit an inquiry dialogue/operation 912 provides the customer with an inquiry form and submits it in order to let the Operator monitor the inquiry and match the lost item if the Operator receives it. The inquiry form can be accessed using 3 modes:
1. Direct access without customer's input on the Display/search matching items dialogue.
2. Access from the Display/search matching item dialogue, including customer's input of the categories filter in case he selected them. The attributes category 1-3 and the date lost are passed over. The customer does not need to enter them again, but is able to change them.
3. Access from the Display/search matching item dialogue, including the categories and a suggested item in case he selected an item. The attributes category 1-3 and the date lost as well as the suggested item are passed over. The customer does not need to enter them again, but is able to change them,

A suggest a matching item dialogue/operation 910 provides the customer with the option to select an item from the display which the customer believes is his lost item and then to start to enter additional data and submit an inquiry. TABLE 12 below details the attribute information entered by the customer when making the inquiry through the website.

TABLE 12
INQUIRY FIXED ATTRIBUTES-CUSTOMER ENTRY

| ATTRIBUTE | DESCRIPTION | INPUT |
|---|---|---|
| Date lost | The date the item has been . lost. This | Calendar control |
| | information is given by the customer. | |
| Category 1 | Main Category of lost item . (identical with | Drop down with |
| | item's . categories) | autocomplete . . . |
| Category 2 | Sub Category (only Cat 2s . that are | Drop down with |
| | assigned to Cat 1 . are possible) . (identical | autocomplete . . . |
| | with items categories) | |
| Category 3 | Sub Category (only Cat 3s . that are | Drop down with |
| | assigned to Cat 2 . are possible) . (identical | autocomplete . . . |
| | with item's . categories) | |
| Color | Selection of administered . colors (may be | Drop down with |
| | “Other”) . (identical with item's . colors) | autocomplete . . . |
| Found where | Selection of administered . locations (may | Drop down with |
| | be “Other”) . Examples: . - . Terminal 1 . - . | autocomplete . . . |
| | Airline X . - . Security area . (identical with | |
| | item's Found . where) | |
| Found where | Location details . . . Mandatory if location is | Free text |
| details | not . provided in “Found where” . (thus | |
| | “Other”) . . . Examples: . - . Flight Number . - | |
| | . Seat XXX | |

In addition to the attributes of TABLE 12, there is optionally a set of 5 additional free text multipurpose attributes. The meaning of these attributes (and thus the field label within the dialogue) varies dependent on the combination of category 1-3. Thus, prompts for these mulitpurpose attributes are displayed after the input of Categories 1, 2 or 3, and refreshed whenever the categories are changed. These multipurpose attributes are used by both the back office and the customer web frontend with identical meanings. However, within the customer user interface the labels of the multipurpose attributes used for the back office are not displayed. Instead, as discussed above and illustrate in the APPENDIX A, (provided at the end of this description), question texts are displayed in order to guide the customer in a more comprehensible way. The question texts are administered in the system settings the way they are regarding the multipurpose attributes labels. The system does not check the content that is entered. A view help text dialogue/operation 920 is provided and allows the customer to view various help information regarding filing an inquiry.

A submit inquiry dialogue/operation 912 allows the customer to submit an inquiry after entering the above referenced fixed attributes, and customer information Based on a set of categories a set of individual attributes is entered is entered in the multipurpose attribute fields. The customer also enters customer address and personal data. Following the customer selecting the submit button, the inquiry is now entered and the IMS 100 automatically sends a confirmation email in response to the entry of the inquiry.

In the above described functionalities, dropdown lists are indicated as being provided with autocomplete. However, this is not a requirement and is an optional feature of the system. As noted above, within the customer web frontend interface the labels of the multipurpose attributes used for the back office are not displayed. Instead of labels, question texts are displayed in order to guide the customer in a more comprehensible way. The question texts are administered in system settings the way they are regarding the multipurpose attributes labels. The label of the note field is different from the back offices label. For example, “Please use this input field in order to describe special marks like stickers, scratches or damages that help us to identify your item.”

The IMS 100 and methodology described herein provide a system and method for matching lost items with inquiries submitted by customers. When a customer has lost an item, the customer starts an inquiry by visiting, calling, emailing or faxing the Operator's L&F counter. The customer will also be encouraged to visit the website domain of the IMS 100 customer web frontend module 205 to process their own inquiry. The customer (or user employee assisting) will enter address and identification information. An inquiry form is completed and submitted/entered to the system; An inquiry confirmation email is generated and delivered to the customer. The system will return a set of possible matches to the inquiry—the results can be sorted and filtered by conditions like ‘found where’ and ‘color’, as examples. Each record containing ‘possible matches’ will have further details regarding the item. The customer submits a claim to the system indicating that the item is their property via the website which pre-assigns an item to an inquiry by setting the status attribute to “c-match” (customer match) for later review by the Operator.

As an alternative to setting a status attribute to indicate a customer match has been made, the item may be moved to a storage location separated from unmatched items as an indicator that it has been matched. Similarly, inquiries that are customer matched may likewise be segregated to indicate the match status. It is to be understood that subsequent processing detailed herein may optionally use segregation to indicate item or inquiry status as an alternative to attribute setting, and reference hereinafter to setting a status attribute, i.e., assignment, pre-assignment, open, resolved, or closed, will be understood to also include optional use of storage location segregation to indicate status.

In response to the customer submitting a claim, the IMS 100 notifies the Operator administrator that a match and a claim have been made for an item so that the match can be confirmed. If the Operator is confident in the match they set the L&F item to match, i.e., the status is changed from “c-matched” to “assigned.” Instead of the customer entering the inquiry via the website, the Operator can optionally enter the inquiry to the IMS 100 in which case the Operator may directly assign an item to an inquiry when confident in a match. In response to an item being assigned to the inquiry, the IMS 100 generates a tracking number, and optionally notifies the customer that they can pick up the item at the office or visit the delivery application (MailMyProperty) for processing and the item's status is set to ‘resolved.’ If the Operator is NOT confident that the match is valid, they can remove the match inquiry from the item. If a match was not successful, the system will automatically perform a search on a daily basis for a defined period of time. The system will optionally automatically notify the customer of this exercise and any new status to their item.

In summary, the IMS 100 system accepts/enters inquiries from customers who have lost items and accepts registrations of found items. The inquiries may be entered by users through user accessible dialogue operations or by customers via the customer website. During entry of either the inquiries or registrations of found items by users, the system optionally automatically presents a list of possible matches. The user can then either assign or pre-assign the inquiry to the item. In an alternative embodiment, the user is only given the option to assign the inquiry to the item. Once an item is assigned to an inquiry, the customer is automatically notified and the item is returned to the customer as described above. If a match is not initially made, the IMS 100 automatically runs searches for matches, notifies the Operator of possible matches, and optionally notifies the associated customers with results of the searches.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

APPENDIX A
Flight, if you lost it in a flight (Ex LH

| A. | | (iv) Casina? | (ii) Wine? |
|---|---|---|---|
| 2414) | | (v) Contax? | (iii) Whiskey? |
| | Art | (vi) Fuji? | (iv) Gin? |
| B. | | (vii) Hasselblad? | (v) Cognac? |
| | 1. Art | (viii) JVC? | (vi) Liqueur? |

| | | |
|---|---|---|
| a) Art Other | (ix) Kodak? | (vii) Other? |

| | | |
|---|---|---|
| (1) Type of Art? | (x) Konica? | (viii) Vodka? |

| | | |
|---|---|---|
| b) Painting | (xi) Lecia? | (ix) Rum? |

| | | |
|---|---|---|
| (1) What kind of painting? | (xii) Mamiya? | (2) How many items? |

| | | |
|---|---|---|
| c) Poster | (xiii) Minolta? | b) Cigarettes |

| | | |
|---|---|---|
| (1) What is on the poster? | (xiv) Minox? | (1) How many packs of |
| (2) Is the poster inside a tube? | (xv) Nikon? | cigarettes? |

| | | |
|---|---|---|
| d) Souvenir | (xvi) Olympus? | c) Tobacco |

| | | |
|---|---|---|
| (1) Type of Souvenir? | (xvii) Philips? | (1) What kind of tobacco? |

| | | |
|---|---|---|
| Books/Magazines | (xviii) Panasonic? | (2) How many items? |

| | | |
|---|---|---|
| C. | (xix) Pentax? | Clothing |

| | | |
|---|---|---|
| (1) What language? | (xx) Petri? | F. |

| | | |
|---|---|---|
| (2) Name of author? | (xxi) Polaroid? | (1) Any kind of pattern? |
| (3) Title of Book/Magazine? | (xxii) Rioch? | (2) What is the material? |

| | | |
|---|---|---|
| 2. Books/Magazines | (xxiii) Samsung? | (3) What make/Brand? |

| | | |
|---|---|---|
| a) Hardback books | (xxiv) Sanyo? | (4) Size? |
| b) Magazines Various | (xxv) Sharp? | (5) Any special Marks? |
| c) Paperback Books | (xxvi) Sony? | (6) Children/Baby size? |

| | | |
|---|---|---|
| Camera | (xxvii) Tamron? | 2. Clothing |

| | | |
|---|---|---|
| D. | (xxviii) Toshiba? | a) Belt |

| | | |
|---|---|---|
| (1) Does it come with a charger? | (xxix) Trust? | (1) Type of Belt? |

| | | |
|---|---|---|
| (2) Serial Number? | (xxx) Vivitar? | b) Blouse |
| (3) Does it come with camera bag? | (xxxi) Yashica? | c) Breeches |
| If so, what color? | (xxxii) Don't know/Other? | d) Cardigan |

| | | |
|---|---|---|
| (i) Blue | (xxxiii) One- Time- | e) Clothing Other |
| (ii) Red | Use- Camera? | f) Costume |

| | | |
|---|---|---|
| (iii) Black | (xxxiv) Go Pro? | (1) Full Costume? |

| | | |
|---|---|---|
| (iv) Brown | (xxxv) Other? | g) Dress |

| | | |
|---|---|---|
| (v) Yellow | 2. Photo Camera | (1) What type of dress? |

| | | |
|---|---|---|
| (vi) White | (1) What kind of photos recently | h) Gloves |

| | | |
|---|---|---|
| (vii) Pink | taken? | (1) One or both gloves missing? |

| | | |
|---|---|---|
| (viii) Purple | b) Compact Camera | (a)One- The right hand |
| (ix) Grey | c) System Camera | is missing? |

| | | |
|---|---|---|
| (x) No Camera bag | 3. Video Camera | (b) One- The left hand |

| | | |
|---|---|---|
| (xi) Green | a) Video Camera | is missing? |

| | | |
|---|---|---|
| (xii) Orange | Cigarettes/Tobacco/Alcohol | (c)Both? |

| | | |
|---|---|---|
| (4) Which camera model? | E. | (2) What kind of gloves? |

| | | |
|---|---|---|
| (5) What brand? | (1) What make/brand? | i) Scarf/Shawl |

| | | |
|---|---|---|
| (i) Agfa? | 2. Cigarettes/Tobacco/Alcohol | j) Shoes/Boots |

| | | |
|---|---|---|
| (ii) Canon? | a) Alcohol | (1) What kind of shoe/Boots? |

| | | |
|---|---|---|
| (iii) Carl Zeiss? | (1) What kind of alcohol? | k) Tie |

| | | |
|---|---|---|
| 1) Uniform | (i) Beer? | 4. Tablet |

| | | |
|---|---|---|
| 3. Headgear | (2) Any stickers or scratches? | (1) IMEI number? |

| | | |
|---|---|---|
| a) Cap | (3) Serial Number? | (2) SIM card provider? |

| | | |
|---|---|---|
| b) Ear Protector | 2. Desktop/Computer | (3) Does it require a |

| | | |
|---|---|---|
| c) Hat | (1) Any other computer | code/Password? |
| d) Headgear Other | components? | (4) Color of the case? |

| | | |
|---|---|---|
| e) Peaked Cap | (2) Any visible make/brand? | (a)No case |

| | | |
|---|---|---|
| f) Sunhat | b) Desktop/Computer | (b) Black |

| | | |
|---|---|---|
| 4. Jackets | 3. Laptop/Computer | (c)White |

| | | |
|---|---|---|
| (1) Any stuff in the pockets? | (1) Which computer model? | (d) Grey |
| (2) Any hood? | (2) What is the username on the | (e)Red |
| (3) How do you close it? | computer? | (f)Blue |

| | | |
|---|---|---|
| (a)Zipper? | (3) Does it come with a charger? | (g) Green |
| (b) Buttons? | (4) Does it come with a mouse? | (h) Brown |
| (c)Tied bands? | (5) Color of the case? | (i) Yellow |

| | | |
|---|---|---|
| (d) Don't know/Other? | (a)Black | (j) Beige |

| | | |
|---|---|---|
| b) Coat | (b) No case | (k) Orange |
| c) Jackets | (c)White | (l) Gold |

| | | |
|---|---|---|
| (1) Type of Jacket? | (d) Grey | (m) Silver |
| (2) Jean Jacket? | (e)Green | (n) Bronze |
| (3) Don't know/Other? | (f)Blue | (o) Transparent |
| (4) Leather Jacket? | (g) Red | (p) Pink |
| (5) Rain Jacket? | (h) Yellow | (q) Purple |

| | | |
|---|---|---|
| (6) Suit Jacket? | (i) Pink | b) Tablet |

| | | |
|---|---|---|
| (7) Training jacket? | (j) Purple | (1) Which tablet model? |
| (8) Wind Jacket? | (k) Brown | (2) Which make/brand? |

| | | |
|---|---|---|
| (9) Softshell Jacket? | (l) Beige | (a)Acer |
| (10) Fleece Jacket? | (m) Orange | (b) Asus |
| (11) Winter Jacket? | (n) Transparent | (c) Ipad |

| | | |
|---|---|---|
| d) Jackets Other | (o) Gold | (d) Lenovo |

| | | |
|---|---|---|
| (1) Type of Jacket? | (p) Bronze | (e)Microsoft |

| | | |
|---|---|---|
| 5. Shirts | (q) Silver | (f) Samsung |

| | | |
|---|---|---|
| (1) Any text/symbols on the shirt? | (6) What is the make/Brand | (g) Other |

| | | |
|---|---|---|
| (2) Any hood? | (a)Toshiba | Electronics |

| | | |
|---|---|---|
| b) Shirt | (b) Sony | H. |

| | | |
|---|---|---|
| c) Sweater | (c)Samsung | (1) What brand? |
| d) T-shirt | (d) Panasonic | (2) Is the device in a casing/ |

| | | |
|---|---|---|
| 6. Trousers | (e)LG | folder? |

| | | |
|---|---|---|
| (1) Anything inside the pockets? | (f) Lenovo | 2. Cables |

| | | |
|---|---|---|
| b) Jeans | (g) HP | a) Cables Other |

| | | |
|---|---|---|
| c) Leather Breeches | (h) Fujitsu | (1) What kind of cable? |

| | | |
|---|---|---|
| d) Shorts | (i) Dell | b) Cellphone Charger |
| e) Skirt | (j) Compaq | c) Laptop Charger |
| f) Sweatpants | (k) Asus | d) USB Cable |

| | | |
|---|---|---|
| g) Trousers Other | (l) Apple | 3. Electronics |

| | | |
|---|---|---|
| Computer Equipment | (m) Acer | a) Battery |

| | | |
|---|---|---|
| G. | (n) Other | (1) What kind of battery? |

| | | |
|---|---|---|
| (1) Does it come with headphones? | b) Laptop/Computer | b) Bluetooth Headset |

| | | |
|---|---|---|
| (1) Movie or music discs? | (c)Don't know/Other | c) CD/DVD/BD |

| | | |
|---|---|---|
| d) Electronics Other | 6. Media and Music Player | 2. Glasses |

| | | |
|---|---|---|
| e) Fitness Device | (1) Name a few artist and titles? | a) Glasses |

| | | |
|---|---|---|
| (1) What kind of device? | (2) What storage size? | b) Reading Glasses |

| | | |
|---|---|---|
| f) Hard Drive | b) IPod | c) Sun Glasses |

| | | |
|---|---|---|
| (1) What storage size? | (1) Which phone model? | Jewelry |

| | | |
|---|---|---|
| (2) External or internal drive? | (a)IPod Classic | J. |

| | | |
|---|---|---|
| (a)Internal | (b) IPod Mini | (1) Any visible brand? |
| (b) External | (c)IPod Nano | (2) What material? |

| | | |
|---|---|---|
| g) Headphones | (d) IPod Shuffle | (3) Any decorative elements? |
| h) Keyboard | (e)Don't know/Other | (4) Any inscriptions? |

| | | |
|---|---|---|
| i) Modem | (f)IPod Touch | 2. Jewelry |

| | | |
|---|---|---|
| (1) Simcard provider? | c) Media Player | a) Bangle |

| | | |
|---|---|---|
| j) Remote Control | d) Music Player | b) Bracelet |

| | | |
|---|---|---|
| 4. E-Reader | 7. USB Flash Drive | c) Earring |

| | | |
|---|---|---|
| (1) Name some of the tittle from the | (1) What size Storage? | d) Jewelry Other |

| | | |
|---|---|---|
| book? | (a)More than 8 GB | e) Necklace |
| (2) Serial number? | (b) Less than 8 GB | f) Ring |

| | | |
|---|---|---|
| (3) Any e-mail registered on the | (c)Don't know/Other | Keys |

| | | |
|---|---|---|
| device? | b) USB Flash Drive | K. |

| | | |
|---|---|---|
| (4) Which Model? | Glasses | (1) How many keys? |

| | | |
|---|---|---|
| b) E-Reader Other | I. | (2) Does the keys have any |

| | | |
|---|---|---|
| c) Kindle | (1) Material of frame? | tracking tag attached to it? |
| d) Nook | (2) Brand of the Glasses? | (3) ID number on keys? |
| e) Samsung | (3) Hard or soft case? | (4) Is it in a case? |

| | | |
|---|---|---|
| f) Sony | (a)Soft Case | (5) Any other unique details |

| | | |
|---|---|---|
| 5. Game Console | (b) Hard Case | (bottle opener, lanyard)? |

| | | |
|---|---|---|
| (1) Any games attached to the | (c)No Case | 2. Car Keys |

| | | |
|---|---|---|
| console? | (d) What color is the | (1) Which car model? |

| | | |
|---|---|---|
| b) Game Console Other | case? | (a)Audi |

| | | |
|---|---|---|
| (1) Which phone model? | (e)Blue | (b) BMW |

| | | |
|---|---|---|
| c) Nintendo | (f)Red | (c)Citroen |

| | | |
|---|---|---|
| (1) Which phone model? | (g) White | (d) Don't know/Other |

| | | |
|---|---|---|
| (a)Nintendo DS | (h) Green | (e)Ford |
| (b) Nintendo DS Lite | (i) Black | (f)Land Rover |
| (c)Nintendo DSi | (j) Brown | (g) Mercedes |
| (d) Nintendo DSI XL | (k) Grey | (h) Peugeot |
| (e)Nintendo 3DS | (l) Yellow | (i) Renault |
| (f) Nintendo 3DS XL | (m) Orange | (j) SAAB |
| (g) Nintendo 2DS | (n) Pink | (k) Volvo |
| (h) Don't know/Other | (o) Purple | (l) Toyota |

| | | |
|---|---|---|
| d) PlayStation | (p) Multicolored | (m) Volkswagen |

| | | |
|---|---|---|
| (1) Which model? | (q) Transparent | (n) Fiat |

| | | |
|---|---|---|
| (a)First-generation | (r) Gold | (o) Skoda |
| (PCH-1000 series) | (s)Silver | (p) Jaguar |
| (b) Second-generation | (t) Beige | (q) Porsche |
| (PCH-2000 series) | (u) Other | (r)Subaru |

| | | |
|---|---|---|
| (u) SEAT | (4) Any text or picture on the | (s)Mazda |
| (v) Nissan | case? | (t)Honda |

| | | |
|---|---|---|
| (w) Opel | b) HTC | (2) Any ID number on the |

| | | |
|---|---|---|
| (x) Dacia | (1) What kind of tablet? | card/cards? |

| | | |
|---|---|---|
| (y) Jeep | c) Huawei | b) Airline Loyalty Card |

| | | |
|---|---|---|
| (z)Ferrari | (1) Which phone model? | (1) Which airline? |

| | | |
|---|---|---|
| (aa) Hyundai | d) IPhone | c) Bank/Credit Card |

| | | |
|---|---|---|
| (bb) Pontiac | (1) iPhone 5c (A1532, A152x, | (1) What kind of bank card is it? |

| | | |
|---|---|---|
| (cc) Chevrolet | A1516, A1507, A1456) | d) Driver's License/ID Card |

| | | |
|---|---|---|
| (dd) Suzuki | (2) IPhone 5c (A1532, A152x, | (1) Day of the birth |
| (ee) Lamborghini | A1516, A1507, A1456) | (yyyy-mm-dd) |
| (ff) Daewoo | (3) IPhone 5s (A153x, A1528, | (2) What nationality are the |
| (gg) Aston Martin | A1518, A1457, A1453) | documents? |

| | | |
|---|---|---|
| (hh) Rolls Royce | (4) IPhone 6 (A1549, A1586) | e) ID Card Other |

| | | |
|---|---|---|
| (ii) Lexus | (5) IPhone 6 Plus (A1522, A1524) | (1) Any nationality on the |

| | | |
|---|---|---|
| b) Car Keys | (6) Don't know/Other | ID-card? |

| | | |
|---|---|---|
| 3. Keys | e) LG | 3. Passport |

| | | |
|---|---|---|
| a) House Keys | (1) Which phone model? | a) Passport |

| | | |
|---|---|---|
| b) Key Card/Electronic Key | f) Mobile Phone Other | (1) Nationality as seen in the |

| | | |
|---|---|---|
| c) Various Keys | (1) What brand of phone? | passport? |

| | | |
|---|---|---|
| Mobile Phones | g) Motorola | (2) First name in the passport? |

| | | |
|---|---|---|
| L. | (1) Which phone model? | (3) Last name in the passport? |

| | | |
|---|---|---|
| (1) Does it have a case? | h) Nokia | (4) Date of birth? (yyyy-mm-dd) |

| | | |
|---|---|---|
| (2) What is the IMEI number? | (1) What kind of tablet? | 4. Wallet |

| | | |
|---|---|---|
| (3) Serial number? | i) Phillips | (I) What is the material? |

| | | |
|---|---|---|
| (4) Other unique features? | (1) Which phone model? | (a)Leather |

| | | |
|---|---|---|
| (5) SIM card Provider? | j) Samsung | (b) Metal |

| | | |
|---|---|---|
| (6) Is it locked with a | (1) Which phone model? | (c)Plastic |

| | | |
|---|---|---|
| password/pincode? | k) Siemens | (d) Other |

| | | |
|---|---|---|
| (7) Color if the case? | (1) What kind of tablet? | (e)Tyg |

| | | |
|---|---|---|
| (a)Blue | l) Sony | b) Case |

| | | |
|---|---|---|
| (b) Red | (1) Which phone model? | (1) What is the amount of cash |

| | | |
|---|---|---|
| (c)Black | m) Sony Ericsson | and currency inside? |

| | | |
|---|---|---|
| (d) White | (1) What kind of tablet? | (2) Any cards inside (bank cards |

| | | |
|---|---|---|
| (e)Yellow | Security Documents | club card)? |

| | | |
|---|---|---|
| (f) Pink | M. | c) Cash |

| | | |
|---|---|---|
| (g) Purple | 1. Documents Various | (1) What is the amount of cash |

| | | |
|---|---|---|
| (h) Gold | (1) Is any name shown? | and what currency? |

| | | |
|---|---|---|
| (i) Silver | (2) Content? | d) Purse |

| | | |
|---|---|---|
| (j) Green | b) Almanac | (1) What is the amount of cash |
| (k) Orange | c) Binder | and currency inside? |
| (l) Brown | d) Documents Other | (2) Any cards inside (bank cards |
| (m) Grey | e) Filofax | club card)? |

| | | |
|---|---|---|
| (n) No case | f) Folder | e) Wallet |

| | | |
|---|---|---|
| 2. Mobile Phone | (1) What kind of folder? | (1) What is the amount of cash |

| | | |
|---|---|---|
| a) Blackberry | 2. ID Card | and currency inside? |

| | | |
|---|---|---|
| (1) Which phone model? | (1) What name is one the | (2) Any cards inside (bank cards |
| (2) Any cards inside (bank cards | card/cards? | club card)? |

| | | |
|---|---|---|
| club card)? | e) Car Seat | f) Wallet Other |

| | | |
|---|---|---|
| Travel Effects | (1) What kind of car seat? | (1) What is the amount of cash |

| | | |
|---|---|---|
| N. | f) Dummy | and currency inside? |

| | | |
|---|---|---|
| (1) What brand? | 3. Medicine/Medical Equipment | (b) Short/Collapsible |

| | | |
|---|---|---|
| (2) Does it have any special marks? | (1) Type of Medicine/Medical | i) Various Others |
| (3) What's inside? | equipment? | j) Walking Stick |

| | | |
|---|---|---|
| b) Bag | (2) Is there any name on it? | (1) What material is it made of? |

| | | |
|---|---|---|
| (1) What is the material? | b) Crutch | (a)Wood |

| | | |
|---|---|---|
| (a)Plastic | c) Hearing Aid | (b) Metal |
| (b) Paper | d) Medical Equipment Other | (c)Plastic |
| (c)Other | e) Medicine | (d) Other |

| | | |
|---|---|---|
| (d) Tyg | f) Sleeping Aid | k) Wheel Chair |

| | | |
|---|---|---|
| c) Bag | 4. Textiles Various | Watch |

| | | |
|---|---|---|
| d) Bag Other | a) Blanket | P. |

| | | |
|---|---|---|
| e) Duty-Free Bag | (1) What kind of blanket? | (1) Analog or digital? |

| | | |
|---|---|---|
| 2. Travel Effects | b) Pillow | (i) Analog |

| | | |
|---|---|---|
| a) Beauty/Toilet Bag | (1) What kind of pillow? | (ii) Digital |

| | | |
|---|---|---|
| b) Briefcase | (a)Neck Pillow | (2) What make/brand? |

| | | |
|---|---|---|
| c) Cabin Sizes Bag | (b) Bed Pillow | (i) Casio |
| d) Handbag | (c)Backrest Pillow | (ii) Citizen |
| e) Hold All | (d) Other | (iii) Rolex |

| | | |
|---|---|---|
| f) Rucksack | c) Rug | (iv) Swatch |
| g) Shoulder Bag | d) Textiles Various Other | (v) Certina |

| | | |
|---|---|---|
| h) Suit Carrier | 5. Toys/Games | (vi) Calvin Klein |

| | | |
|---|---|---|
| i) Travel Effects Other | a) Board/Card Games | (vii) Q & Q |
| j) Trolley Case | b) Dolls | (viii) Seiko |

| | | |
|---|---|---|
| Various | c) Plastic Toys | (ix) Don't know/Other |

| O. | | d) Stuffed Animals | (x) Zenit |
|---|---|---|---|
| | (1) What manufacturer/brand? | e) Toys/Games Others | (xi) Apple Watch |

| | | |
|---|---|---|
| 2. Child Products | (1) What kind of toy/game? | (xii) Breitling |

| | | |
|---|---|---|
| a) Baby Bottle | 6. Various | (xiii) Baume & Mercier |

| | | |
|---|---|---|
| (1) What is the material? | a) Case/Cover | (xiv) Bulova |

| | | |
|---|---|---|
| (a)Metal | (1) What kind of case/cover? | (xv) Cartier |

| | | |
|---|---|---|
| (b) Plastic | b) Food | (xvi) Chopard |

| | | |
|---|---|---|
| (c)Other | (1) What type of food? | (xvii) Daniel Hechter |

| | | |
|---|---|---|
| b) Baby Changing Mat | c) Hygiene Products | (xviii) Ebel |

| | | |
|---|---|---|
| (1) What kind of material/fabric? | (1) What kind of item? | (xix) Etherna |

| | | |
|---|---|---|
| (a)Leather | d) Makeup/Perfume | (xx) Inex |

| | | |
|---|---|---|
| (b) Tyg | (1) What kind of item? | (xxi) IWC |

| | |
|---|---|
| (c)Plastic | e) Musical Instrument |

| | |
|---|---|
| c) Baby Pram | (1) What type of instrument? |

| | |
|---|---|
| (1) What kind of babypram? | f) Sports/Leisure Equipment |

| | |
|---|---|
| d) Bib | (1) What kind of equipment? |

| | |
|---|---|
| (1) What is the material? | g) Tools |

| | |
|---|---|
| (a)Plastic | (1) What kind of tools? |

| | |
|---|---|
| (b) Leather | h) Umbrella |

| | |
|---|---|
| (c)Tyg | (1) Type of umbrella? |

| | |
|---|---|
| (xxii) Longines | (a)Long |

(xxiii) Pulsar
(xxiv) TAG Heuer
(xxv) Times
(xxvi) Tissot
(xxvii) Tudor
(xxviii) Quartz
(xxix) Regal
(xxx) Galant
(xxxi) Hugo Boss
(xxxii) Skagen
(xxxiii) Omega

2. Watch

a) Watch Other

(1) What kind of watch?

b) Wrist Wateh

(1) What colour is the dial?
(2) What material is the wristband?
(3) What color is the wristband?

What is claimed is:

1. A lost item management system controlled by an operator for matching found items provided by finders with lost item inquiries provided by customers, comprising:
an item processing module configured to accept and store item attributes of the found items as parts of item entries, wherein each of said item entries comprises a set of said item attributes corresponding to one of said found items;
an inquiry processing module configured to accept and store inquiry attributes, corresponding to attributes of the lost items, as parts of inquiry entries, wherein each of said inquiries entries comprises a set of said inquiry attributes;
an item matching module configured to execute a match search comparing said item attributes of said item entries with said inquiry attributes of said inquiry entries and identify possible matches between said item entries and said inquiry entries based on at least partial correspondence of said item attributes with said inquiry attributes respectively of said item entries and said inquiry entries; and
a monitoring module configured to actuate said item matching module, in accordance with a schedule, to execute said match search and notify the operator when possible matches are identified by the match search.

2. A lost item management system according to claim 1, further comprising:
a customer web frontend module configured to host a customer website providing input fields for accepting a subset of said set of inquiry attributes from customers as a customer inquiry entry storing said customer inquiry entry as one of said inquiry entries;
said customer web frontend module being configured to trigger said item matching module to execute a match search using the customer inquiry entry and present a listing of possible matches in response to customer input; and
said customer web frontend module being configured to accept a selection of one of said possible matches presented to said customer and store a customer match indication associated with an inquiry entry and an item entry comprising said selected one of said possible matches.

3. A lost item management system according to claim 2, wherein said match search is a weighted search which compares pairs of said item entries and said inquiry entries and produces search scores indicating correspondence of said compared pairs, and a search threshold value is used to determine if ones of said search scores are sufficient to indicate inclusion in said possible matches.

4. A lost item management system according to claim 3, wherein a set of weights is used to conduct said weighted search, and individual ones of said weights correspond to ones of said inquiry attributes and ones of said item attributes, and said set of weights is attribute dependent.

5. A lost item management system according to claim 4, wherein said item attributes and said inquiry attributes include category attributes having predefined settings from which a setting is selected and assigned to a corresponding one of said category attributes, and at least one of said category attributes is an attribute dependent attribute having associated predefined setting determined by settings of at least one other of said category attributes.

6. A lost item management system according to claim 5, wherein said item attributes and said inquiry attributes include multipurpose attributes accepting free text entries, and said item processing module presents category attribute dependent prompts for said multipurpose attributes.

7. A lost item management system according to claim 6, wherein said weighted search is a hybrid search requiring a match between at least one of said item attributes and a corresponding one of said inquiry attributes of said compared pair in order for said weighted search to be applied to said compared pair.

8. A lost item management system according to claim 7, wherein said weighted search includes said search threshold value being at least two search threshold values respectively corresponding to grades of said possible matches.

9. A lost item management system according to claim 8, wherein said search threshold value is attribute dependent.

10. A lost item management system according to claim 8, wherein an assignment threshold value is one of said at least two search threshold values, and said item matching module assigns an item entry to an inquiry entry of said compared pair in response to a search score of said compared pair equaling or exceeding said assignment threshold value, wherein said item matching module sets statuses of said compared pair to assigned and initiates delivering said item of said item entry to said customer.

11. A lost item management system according to claim 10, wherein said item matching module updates a last search date attribute of said inquiry attributes to indicate a date of said match search, and, when executing subsequent match search for a given one of said inquiry entries, reads said last search date attribute and limits said match search to ones of said item entries entered subsequent to said read last search date.

12. A lost item management system according to claim 11, further comprising a lost and found category module configured to maintain designations of said inquiry attributes and said item attributes by accepting input from the operator effecting at least one of deletion, addition, or modification of said designations.

13. A lost item management system according to claim 12, wherein said lost and found category module is further configured to maintain category attribute dependent prompts by accepting input from the operator effecting at least one of deletion, addition, or modification of said category attribute dependent prompts.

14. A lost item management system according to claim 13, wherein said item matching module updates a last search date attribute of said inquiry attributes to indicate a date of said match search, and, when executing subsequent match search for a given one of said inquiry entries, reads said last search date attribute and limits said match search to ones of said item entries entered subsequent to said read last search date.

15. A lost item management system according to claim 1, further comprising a lost and found category module configured to maintain designations of said inquiry attributes and said item attributes by accepting input from the operator effecting at least one of deletion, addition, or modification of said designations.

16. A lost item management system according to claim 15, wherein:
said item attributes and said inquiry attributes include multipurpose attributes accepting free text entries, and said item processing module presents category attribute dependent prompts for said multipurpose attributes; and
said lost and found category module is further configured to maintain category attribute dependent prompts by accepting input from the operator effecting at least one of deletion, addition, or modification of said category attribute dependent prompts.

17. A lost item management system according to claim 2, wherein said customer match indication comprises setting an inquiry attribute and setting an item attribute.

18. A lost item management system according to claim 1, wherein said item matching module updates a last search date attribute of said inquiry attributes to indicate a date of said match search, and, when executing subsequent match search for a given one of said inquiry entries, reads said last search date attribute and limits said match search to ones of said item entries entered subsequent to said read last search date.

19. A lost item management system according to claim 1, further comprising an item deregistration module configured to set an item attribute to expired in response to determining a predetermined time period has passed without said item entry being assigned one of said inquiry entries, and in response to determining the item is expired said item deregistration module assigns a storage location to said item entry designated for an auction partner, and prints auction processing documents.

20. A lost item management system according to claim 1, further compiling an item deregistration module configured to set an item attribute to expired in response to determining a predetermined time period has passed without said item entry being assigned one of said inquiry entries, and in response to determining the item is expired said item deregistration module removes the item from said item entries and assigns the item to one of charity, gross-sale, online sale, destruction, or operator operations based on an estimated value of the item.
